(19) United States
(12) Patent Application Publication
(10) Pub. No.: US 2025/0280425 A1
(43) Pub. Date: Sep. 4, 2025

(54) PRIORITIZING PHYSICAL SIDELINK FEEDBACK CHANNEL COMMUNICATIONS ON MULTIPLE CARRIERS

(71) Applicant: QUALCOMM Incorporated, San Diego, CA (US)

(72) Inventors: Tien Viet NGUYEN, Bridgewater, NJ (US); Gabi SARKIS, San Diego, CA (US); Shuanshuan WU, San Diego, CA (US); Kapil GULATI, Belle Mead, NJ (US); Hui GUO, Beijing (CN); Sourjya DUTTA, Jersey City, NJ (US)

(21) Appl. No.: 18/858,065

(22) PCT Filed: Jul. 1, 2022
(86) PCT No.: PCT/CN2022/103227

§ 371 Date: Oct. 18, 2024

(51) Int. Cl. H04W 72/25; H04L 5/00

(52) U.S. Cl. CPC H04W 72/25; H04L 5/0055

(57) ABSTRACT

Various aspects of the present disclosure generally relate to wireless communication. In some aspects, a mobile station may determine a respective priority, for each carrier of a plurality of carriers on which a plurality of physical sidelink feedback channel (PSFCH) communications are to be transmitted in one or more PSFCH symbols, based at least in part on priorities of one or more PSFCH communications, of the plurality of PSFCH communications, to be transmitted on that carrier. The mobile station may select a number of carriers, of the plurality of carriers, based at least in part on the respective priority determined for each carrier, of the plurality of carriers. The mobile station may transmit, in the one or more PSFCH symbols, by the mobile station to one or more other mobile stations, PSFCH communications, of the plurality of PSFCH communications, on the number of carriers selected. Numerous other aspects are described.

### FIELD OF THE DISCLOSURE

Aspects of the present disclosure generally relate to wireless communication and to techniques and apparatuses for prioritizing physical sidelink feedback channel (PSFCH) communications in carrier aggregation and multiple carrier operation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a mobile station for wireless communication. The mobile station may include a memory and one or more processors coupled to the memory. The one or more processors may be configured to determine a respective priority, for each carrier of a plurality of carriers on which a plurality of physical sidelink feedback channel (PSFCH) communications are to be transmitted in one or more PSFCH symbols, based at least in part on priorities of one or more PSFCH communications, of the plurality of PSFCH communications, to be transmitted on that carrier. The one or more processors may be configured to select a number of carriers, of the plurality of carriers, based at least in part on the respective priority determined for each carrier, of the plurality of carriers. The one or more processors may be configured to transmit, in the one or more PSFCH symbols, to one or more other mobile stations, PSFCH communications, of the plurality of PSFCH communications, on the number of carriers selected.

Some aspects described herein relate to a mobile station for wireless

communication. The mobile station may include a memory and one or more processors coupled to the memory. The one or more processors may be configured to determine a respective priority, for each carrier of a plurality of carriers on which a plurality of PSFCH communications are to be received in one or more PSFCH symbols, based at least in part on priorities of one or more PSFCH communications, of the plurality of PSFCH communications, to be received on that carrier. The one or more processors may be configured to select a number of carriers, of the plurality of carriers, based at least in part on the respective priority determined for each carrier, of the plurality of carriers. The one or more processors may be configured to receive, in the one or more PSFCH symbols, from one or more other mobile stations, PSFCH communications, of the plurality of PSFCH communications, on the number of carriers selected.

Some aspects described herein relate to a mobile station for wireless communication. The mobile station may include a memory and one or more processors coupled to the memory. The one or more processors may be configured to determine a transmission priority for one or more PSFCH symbols based at least in part on first carrier priorities for a first set of carriers on which a first set of PSFCH communications are to be transmitted in the one or more PSFCH symbols. The one or more processors may be configured to determine a reception priority for the one or more PSFCH symbols based at least in part on second carrier priorities for a second set of carriers on which a second set of PSFCH communications are to be received in the one or more PSFCH symbols. The one or more processors may be configured to selectively transmit the first set of PSFCH communications on the first set of carriers in the one or more PSFCH symbols or receive the second set of PSFCH communications on the second set of carriers in the one or more PSFCH symbols, based at least in part on the transmission priority and the reception priority.

Some aspects described herein relate to a method of wireless communication performed by a mobile station. The method may include determining, by the mobile station, a respective priority, for each carrier of a plurality of carriers on which a plurality of PSFCH communications are to be transmitted in one or more PSFCH symbols, based at least in part on priorities of one or more PSFCH communications, of the plurality of PSFCH communications, to be transmitted on that carrier. The method may include selecting, by the mobile station, a number of carriers, of the plurality of carriers, based at least in part on the respective priority determined for each carrier, of the plurality of carriers. The method may include transmitting, in the one or more PSFCH symbols, by the mobile station to one or more other mobile stations, PSFCH communications, of the plurality of PSFCH communications, on the number of carriers selected.

Some aspects described herein relate to a method of wireless communication performed by a mobile station. The method may include determining, by the mobile station, a respective priority, for each carrier of a plurality of carriers on which a plurality of PSFCH communications are to be received in one or more PSFCH symbols, based at least in part on priorities of one or more PSFCH communications, of the plurality of PSFCH communications, to be received on that carrier. The method may include selecting, by the mobile station, a number of carriers, of the plurality of carriers, based at least in part on the respective priority determined for each carrier, of the plurality of carriers. The method may include receiving, in the one or more PSFCH symbols, by the mobile station from one or more other mobile stations, PSFCH communications, of the plurality of PSFCH communications, on the number of carriers selected.

Some aspects described herein relate to a method of wireless communication performed by a mobile station. The method may include determining, by the mobile station, a transmission priority for one or more PSFCH symbols based at least in part on first carrier priorities for a first set of carriers on which a first set of PSFCH communications are to be transmitted in the one or more PSFCH symbols. The method may include determining, by the mobile station, a reception priority for the one or more PSFCH symbols based at least in part on second carrier priorities for a second set of carriers on which a second set of PSFCH communications are to be received in the one or more PSFCH symbols. The method may include selectively transmitting, by the mobile station, the first set of PSFCH communications on the first set of carriers in the one or more PSFCH symbols or receiving, by the mobile station, the second set of PSFCH communications on the second set of carriers in the one or more PSFCH symbols, based at least in part on the transmission priority and the reception priority.

Some aspects described herein relate to a non-transitory computer-readable medium that stores a set of instructions by a mobile station. The set of instructions, when executed by one or more processors of the mobile station, may cause the mobile station to determine a respective priority, for each carrier of a plurality of carriers on which a plurality of PSFCH communications are to be transmitted in one or more PSFCH symbols, based at least in part on priorities of one or more PSFCH communications, of the plurality of PSFCH communications, to be transmitted on that carrier. The set of instructions, when executed by one or more processors of the mobile station, may cause the mobile station to select a number of carriers, of the plurality of carriers, based at least in part on the respective priority determined for each carrier, of the plurality of carriers. The set of instructions, when executed by one or more processors of the mobile station, may cause the mobile station to transmit, in the one or more PSFCH symbols, to one or more other mobile stations, PSFCH communications, of the plurality of PSFCH communications, on the number of carriers selected.

Some aspects described herein relate to a non-transitory computer-readable medium that stores a set of instructions by a mobile station. The set of instructions, when executed by one or more processors of the mobile station, may cause the mobile station to determine a respective priority, for each carrier of a plurality of carriers on which a plurality of PSFCH communications are to be received in one or more PSFCH symbols, based at least in part on priorities of one or more PSFCH communications, of the plurality of PSFCH communications, to be received on that carrier. The set of instructions, when executed by one or more processors of the mobile station, may cause the mobile station to select a number of carriers, of the plurality of carriers, based at least in part on the respective priority determined for each carrier, of the plurality of carriers. The set of instructions, when executed by one or more processors of the mobile station, may cause the mobile station to receive, in the one or more PSFCH symbols, from one or more other mobile stations, PSFCH communications, of the plurality of PSFCH communications, on the number of carriers selected.

Some aspects described herein relate to a non-transitory computer-readable medium that stores a set of instructions by a mobile station. The set of instructions, when executed by one or more processors of the mobile station, may cause the mobile station to determine a transmission priority for one or more PSFCH symbols based at least in part on first carrier priorities for a first set of carriers on which a first set of PSFCH communications are to be transmitted in the one or more PSFCH symbols. The set of instructions, when executed by one or more processors of the mobile station, may cause the mobile station to determine a reception priority for the one or more PSFCH symbols based at least in part on second carrier priorities for a second set of carriers on which a second set of PSFCH communications are to be received in the one or more PSFCH symbols. The set of instructions, when executed by one or more processors of the mobile station, may cause the mobile station to selectively transmit the first set of PSFCH communications on the first set of carriers in the one or more PSFCH symbols or receive the second set of PSFCH communications on the second set of carriers in the one or more PSFCH symbols, based at least in part on the transmission priority and the reception priority.

Some aspects described herein relate to an apparatus. The apparatus may include means for determining a respective priority, for each carrier of a plurality of carriers on which a plurality of PSFCH communications are to be transmitted in one or more PSFCH symbols, based at least in part on priorities of one or more PSFCH communications, of the plurality of PSFCH communications, to be transmitted on that carrier. The apparatus may include means for selecting a number of carriers, of the plurality of carriers, based at least in part on the respective priority determined for each carrier, of the plurality of carriers. The apparatus may include means for transmitting, in the one or more PSFCH symbols, PSFCH communications, of the plurality of PSFCH communications, on the number of carriers selected.

Some aspects described herein relate to an apparatus. The apparatus may include means for determining a respective priority, for each carrier of a plurality of carriers on which a plurality of PSFCH communications are to be received in one or more PSFCH symbols, based at least in part on priorities of one or more PSFCH communications, of the plurality of PSFCH communications, to be received on that carrier. The apparatus may include means for selecting a number of carriers, of the plurality of carriers, based at least in part on the respective priority determined for each carrier, of the plurality of carriers. The apparatus may include means for receiving, in the one or more PSFCH symbols, PSFCH communications, of the plurality of PSFCH communications, on the number of carriers selected.

Some aspects described herein relate to an apparatus. The apparatus may include means for determining a transmission priority for one or more PSFCH symbols based at least in part on first carrier priorities for a first set of carriers on which a first set of PSFCH communications are to be transmitted in the one or more PSFCH symbols. The apparatus may include means for determining a reception priority for the one or more PSFCH symbols based at least in part on second carrier priorities for a second set of carriers on which a second set of PSFCH communications are to be received in the one or more PSFCH symbols. The apparatus may include means for selectively transmitting the first set of PSFCH communications on the first set of carriers in the one or more PSFCH symbols or receiving the second set of PSFCH communications on the second set of carriers in the one or more PSFCH symbols, based at least in part on the transmission priority and the reception priority.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of a slot structure for sidelink communications, in accordance with the present disclosure.

FIG. 6 is a diagram illustrating an example of physical sidelink feedback channel (PSFCH) resource mapping, in accordance with the present disclosure.

FIGS. 7-9 are diagrams illustrating examples associated with prioritizing PSFCH communications in carrier aggregation and multiple carrier operation, in accordance with the present disclosure.

FIGS. 10-12 are diagrams illustrating example processes associated with prioritizing PSFCH communications in carrier aggregation and multiple carrier operation, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

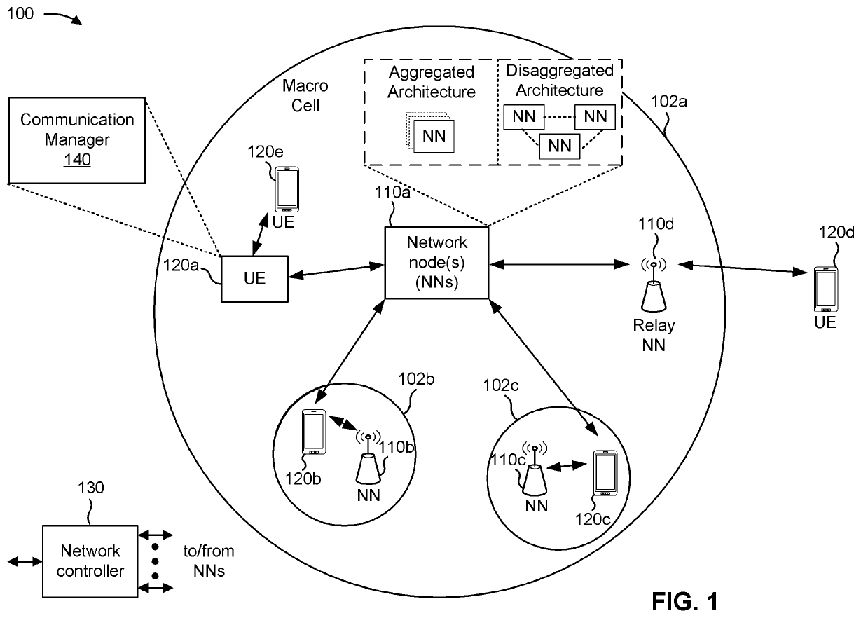

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a mobile station (e.g., the UE 120) may include a communication manager 140. As described in more detail elsewhere herein, the communication manager 140 may determine a respective priority, for each carrier of a plurality of carriers on which a plurality of physical sidelink feedback channel (PSFCH) communications are to be transmitted in one or more PSFCH symbols, based at least in part on priorities of one or more PSFCH communications, of the plurality of PSFCH communications, to be transmitted on that carrier; select a number of carriers, of the plurality of carriers, based at least in part on the respective priority determined for each carrier, of the plurality of carriers; and transmit, in the one or more PSFCH symbols, to one or more other mobile stations, PSFCH communications, of the plurality of PSFCH communications, on the number of carriers selected. Additionally, or alternatively, the communication manager 140 may perform one or more other operations described herein.

In some aspects, as described in more detail elsewhere, the communication manager 140 may determine a respective priority, for each carrier of a plurality of carriers on which a PSFCH communications are to be received in one or more PSFCH symbols, based at least in part on priorities of one or more PSFCH communications, of the plurality of PSFCH communications, to be received on that carrier; select a number of carriers, of the plurality of carriers, based at least in part on the respective priority determined for each carrier, of the plurality of carriers; and receive PSFCH communications, of the plurality of PSFCH communications, on the number of carriers selected. Additionally, or alternatively, the communication manager 140 may perform one or more other operations described herein.

In some aspects, as described in more detail elsewhere herein, the communication manager 140 may determine a transmission priority for one or more PSFCH symbols based at least in part on first carrier priorities for a first set of carriers on which a first set of PSFCH communications are to be transmitted in the one or more PSFCH symbols; determine a reception priority for the one or more PSFCH symbols based at least in part on second carrier priorities for a second set of carriers on which a second set of PSFCH communications are to be received in the one or more PSFCH symbols; and selectively transmit the first set of PSFCH communications on the first set of carriers in the one or more PSFCH symbols or receive the second set of PSFCH communications on the second set of carriers in the one or more PSFCH symbols, based at least in part on the transmission priority and the reception priority. Additionally, or alternatively, the communication manager 140 may perform one or more other operations described herein.

As indicated above, FIG. 1 is provided as an example. Other examples may differ from what is described with regard to FIG. 1.

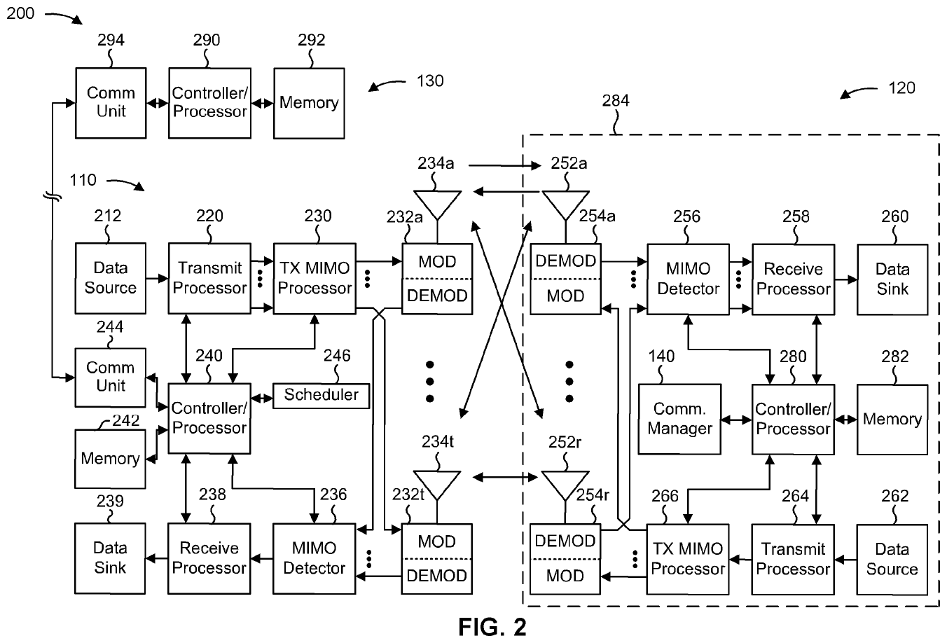

FIG. 2 is a diagram illustrating an example 200 of a network node 110 in communication with a user equipment (UE) 120 in a wireless network 100, in accordance with the present disclosure. The network node 110 may be equipped with a set of antennas 234a through 234t, such as T′ antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T′ output symbol streams) to a corresponding set of modems 232 (e.g., T′ modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

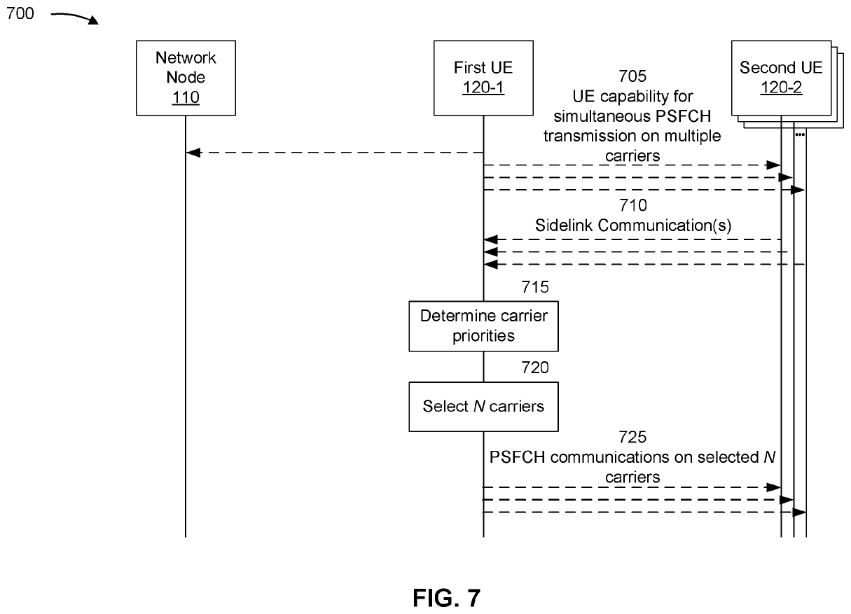

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-13).

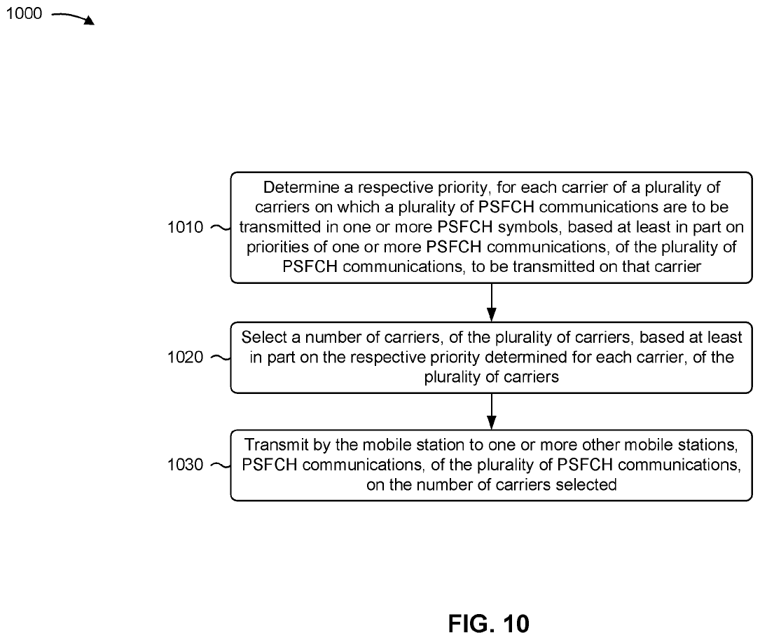

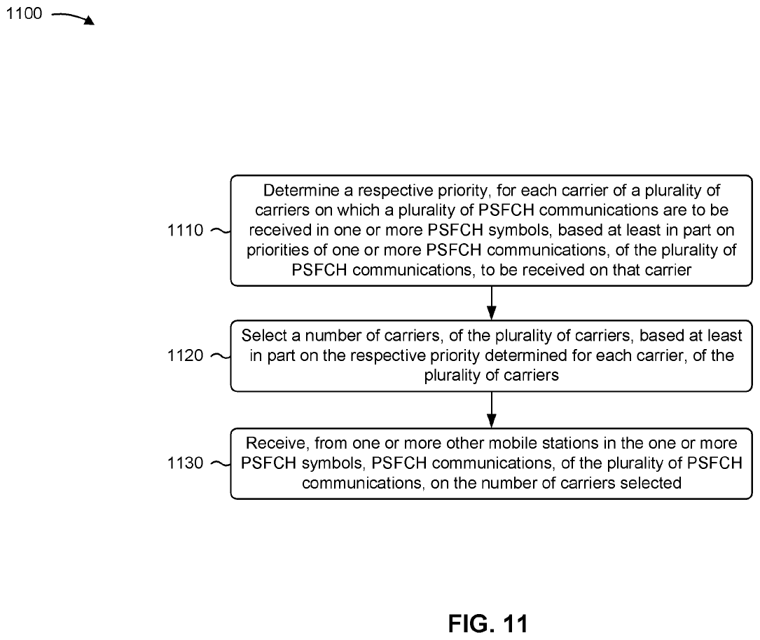

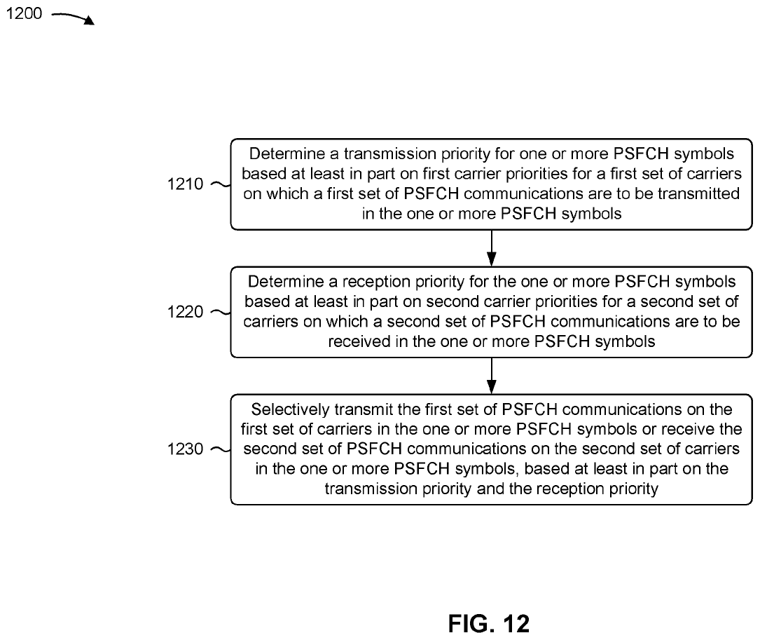

The controller/processor 240 of the network node 110, the controller/processor 280 of the UE 120, and/or any other component(s) of FIG. 2 may perform one or more techniques associated with prioritization of PSFCH communications in carrier aggregation and multiple carrier operation, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples. In some aspects, a mobile station described herein is the UE 120, is included in the UE 120, or includes one or more components of the UE 120 shown in FIG. 2.

In some aspects, a mobile station includes means for determining, by the mobile station, a respective priority, for each carrier of a plurality of carriers on which a plurality of PSFCH communications are to be transmitted in one or more PSFCH symbols, based at least in part on priorities of one or more PSFCH communications, of the plurality of PSFCH communications, to be transmitted on that carrier; means for selecting, by the mobile station, a number of carriers, of the plurality of carriers, based at least in part on the respective priority determined for each carrier, of the plurality of carriers; and/or means for transmitting, in the one or more PSFCH symbols, by the mobile station to one or more other mobile stations, PSFCH communications, of the plurality of PSFCH communications, on the number of carriers selected. In some aspects, the means for the mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a mobile station includes means for determining, by the mobile station, a respective priority, for each carrier of a plurality of carriers on which a plurality of PSFCH communications are to be received in one or more PSFCH symbols, based at least in part on priorities of one or more PSFCH communications, of the plurality of PSFCH communications, to be received on that carrier; means for selecting, by the mobile station, a number of carriers, of the plurality of carriers, based at least in part on the respective priority determined for each carrier, of the plurality of carriers; and/or means for receiving, by the mobile station from one or more other mobile stations in the one or more PSFCH symbols, PSFCH communications, of the plurality of PSFCH communications, on the number of carriers selected. In some aspects, the means for the mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a mobile station includes means for determining, by the mobile station, a transmission priority for one or more PSFCH symbols based at least in part on first carrier priorities for a first set of carriers on which a first set of PSFCH communications are to be transmitted in the one or more PSFCH symbols; means for determining, by the mobile station, a reception priority for the one or more PSFCH symbols based at least in part on second carrier priorities for a second set of carriers on which a second set of PSFCH communications are to be received in the one or more PSFCH symbols; and/or means for selectively transmitting, by the mobile station, the first set of PSFCH communications on the first set of carriers in the one or more PSFCH symbols or receiving, by the mobile station, the second set of PSFCH communications on the second set of carriers in the one or more PSFCH symbols, based at least in part on the transmission priority and the reception priority. In some aspects, the means for the mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

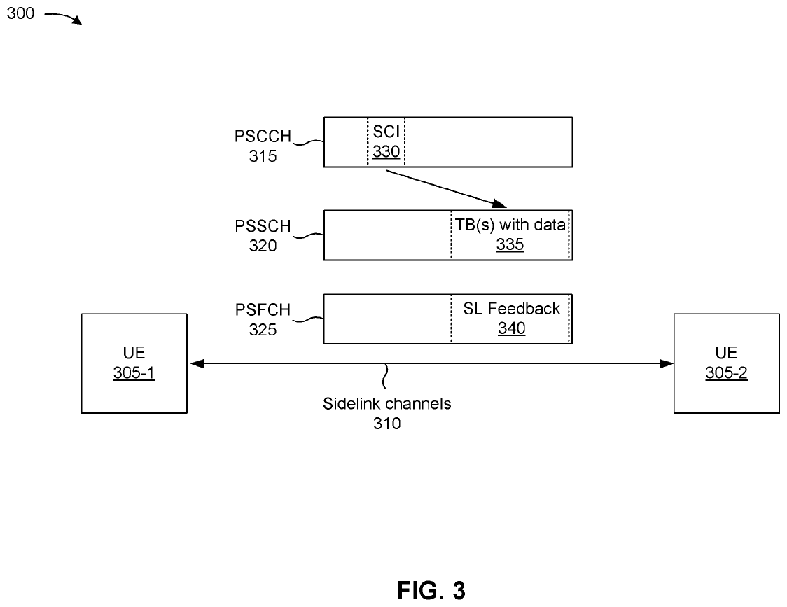

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a PSFCH 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink resource allocation mode (e.g., Mode 1) where resource selection and/or scheduling is performed by a network node 110. For example, the UE 305 may receive a grant (e.g., in downlink control information (DCI) or in a radio resource control (RRC) message, such as for configured grants) from the network node 110 for sidelink channel access and/or scheduling. In some aspects, a UE 305 may operate using a resource allocation mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the resource allocation mode where resource selection and/or scheduling is performed by a UE 305 (e.g., Mode 2), the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

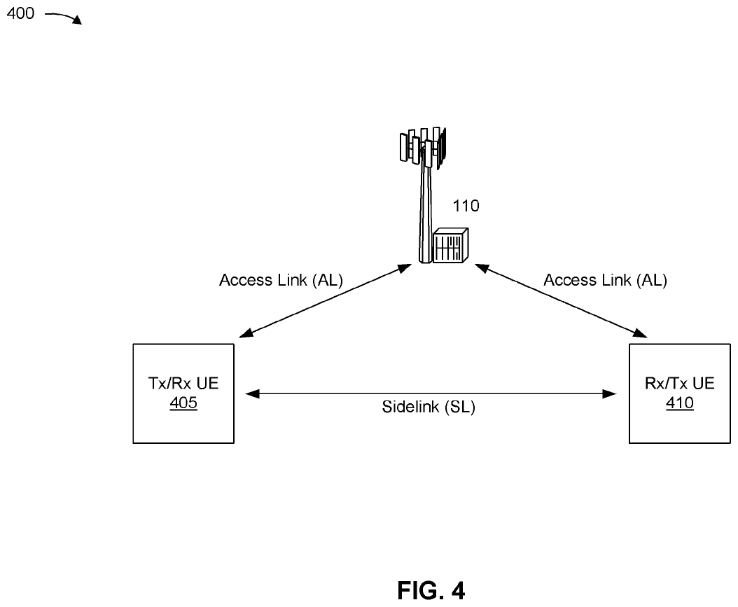

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 via a first access link. Additionally, or alternatively, in some sidelink modes, the network node 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

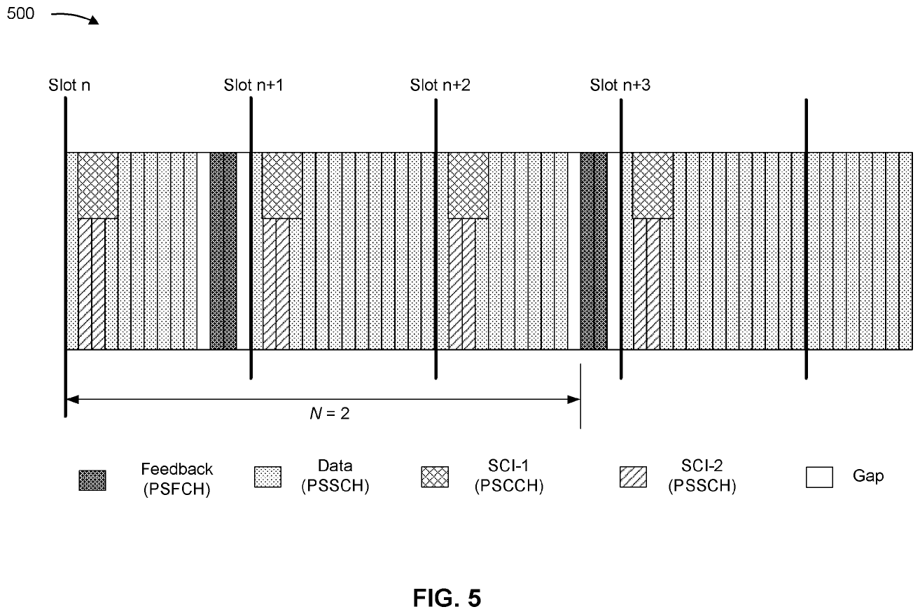

FIG. 5 is a diagram illustrating an example 500 of a slot structure for sidelink communications, in accordance with the present disclosure.

As shown in FIG. 5, a slot structure for sidelink communications may include SCI-1 resources (e.g., PSCCH time and frequency resources), SCI-2 resources (e.g., PSSCH time and frequency resources for SCI-2), data resources (e.g., PSSCH time and frequency resources for sidelink data), and feedback resources (e.g., PSFCH time and frequency resources). The feedback resources (or “PSFCH resources”) may be system- wide resources to be used by sidelink UEs associated with a resource pool to transmit and receive PSFCH communications, including feedback (e.g., HARQ ACK/NACK feedback) for PSSCH communications. In some examples, the PSFCH resources may be configured with a period of N=0, 1, 2, or 4 slots. For example, in FIG. 5, the period of the PSFCH resources is N=2 slots. A period of N=0 for the PSFCH resources may correspond to PSFCH transmissions being disabled for the sidelink UEs. The PSFCH resources may include two OFDM symbols in a slot. The OFDM symbols allocated for the PSFCH resources may be referred to as “PSFCH symbols.” A gap symbol may be included between the data resources (e.g., PSSCH resources) and the PSFCH symbols.

In some examples, PSFCH format 0 may be used for PSFCH communications including HARQ ACK/NACK feedback. A PSFCH format 0 sequence on one RB may carry HARQ ACK/NACK information for a single PSSCH communication. The PSFCH format 0 sequence, that carries the feedback for a PSSCH communication, may be repeated on both PSFCH symbols in a slot.

In some examples, PSFCH transmissions may be enabled for unicast sidelink communications and groupcast sidelink communications. In the case of unicast sidelink communications, an Rx UE that receives a PSSCH communication may transmit, to a Tx UE, a PSFCH communication that includes a one-bit ACK/NACK indication. In some examples, in the case of groupcast sidelink communications, an RX UE may transmit only NACK feedback in PSFCH communications. In some examples, in the case of groupcast sidelink communications, an Rx UE may transmit ACK or NACK feedback in PSFCH communications.

As indicated above, FIG. 5 is provided as an example. Other examples may differ from what is described with respect to FIG. 5.

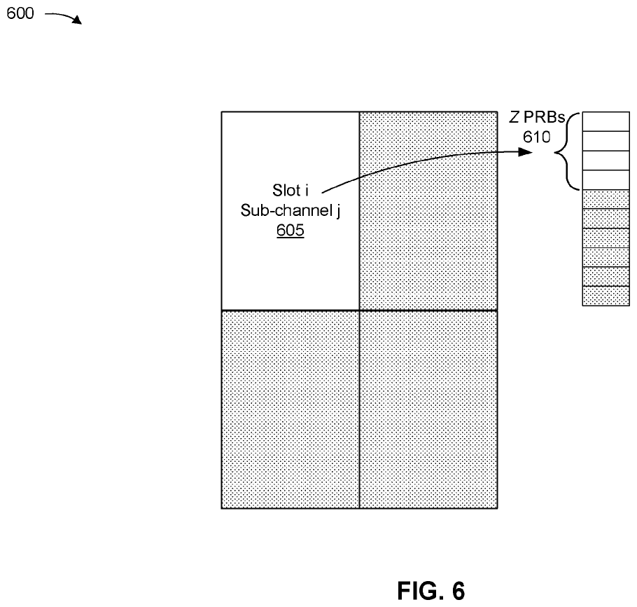

FIG. 6 is a diagram illustrating an example 600 of PSFCH resource mapping, in accordance with the present disclosure.

PSFCH communications transmitted in a PSFCH symbol may be multiplexed in the frequency domain and the code domain. The frequency resource for a PSFCH communication may be one physical resource block (PRB), and the code resource for a PSFCH communication may be a cyclic shift of a base sequence in one PRB. In some cases, the PSFCH resource for transmitting the feedback for a PSSCH communication may be based at least in part on the PSSCH resources in which the PSSCH communication is transmitted. In some examples, a UE may determine a set of PRBs for a PSFCH communication based at least in part on a PSSCH resource index of a PSSCH communication. As shown in FIG. 6, a slot i and a sub-channel j (e.g., corresponding to a PSSCH resource), shown by reference number 605, may map to a set of Z PRBs 610. Each PRB, of the set of Z PRBs, may have Y pairs of cyclic shifts. For each pair of cyclic shifts, one cyclic shift value may be used for ACK and the other cyclic shift value may be used for NACK. In some examples, the UE may determine a PSFCH resource, for a PSFCH communication, from the Z*Y PSFCH resources (e.g., from the set of Z PRBs and the Y pairs of cyclic shifts for each PRB) based at least in part on one or more UE identifiers (IDs).

In some examples, a UE may determine the PSFCH resource for HARQ ACK/NACK for a unicast sidelink communication as: ID_{L1-source} mod(Z*Y), where ID_{L1-source} is the UE ID of the source UE of the sidelink communication. In some examples, a UE may determine the PSFCH resource for NACK-only feedback for a groupcast sidelink communication as: ID_{L1-source} mod(Z*Y). In this case, the cyclic shift values for ACK may not be used. In some examples, a UE may determine the PSFCH resource for ACK or NACK feedback for a groupcast sidelink communication as: (ID_{L1-source}+M) mod(Z*Y), where M is a member ID (e.g., UE ID) of the receiver UE in the group.

As indicated above, FIG. 6 is provided as an example. Other examples may differ from what is described with respect to FIG. 6.

Carrier aggregation is a technology that enables two or more component carriers (CCs, sometimes referred to as carriers) to be combined (e.g., into a single channel) for a UE to enhance data capacity. As of Release 16 (Rel-16) of the 3GPP wireless communication standard, sidelink carrier aggregation is not supported for NR/5G sidelink communications (e.g., NR V2X). In some aspects, sidelink carrier aggregation and/or multiple carrier operation may increase the bandwidth available for sidelink communications, which may result in increased throughput that may be used for various sidelink applications. For example, sidelink carrier aggregation and/or multiple carrier operation may be beneficial for providing increased operation bandwidth for high data rate applications or services, as well as for providing redundancy over multiple carriers for low latency and high reliability applications or services, such as industrial IoT (IIoT), mission-critical sensing and control, video surveillance, and/or extended reality (XR) (e.g., virtual reality and/or augmented reality (AR)), among other examples. In some aspects, sidelink carrier aggregation and/or multiple carrier operation may be used to enable sidelink UEs to operate in multiple adjacent channels. In some cases, in sidelink carrier aggregation and/or multiple carrier operation, a UE may be scheduled to transmit and/or receive PSFCH communications simultaneously on multiple different carriers. However, when a UE transmits a PSFCH communication on one carrier, the UE may not be able to receive PSFCH communications on any other carriers. Furthermore, PSFCH communications scheduled to be simultaneously transmitted or received on multiple different carriers may exceed a capability of the UE.

Some techniques and apparatuses described herein enable a mobile station (e.g., a UE) to determine a respective priority, for each carrier of a plurality of carriers on which a plurality of PSFCH communications are to be transmitted in one or more PSFCH symbols, based at least in part on priorities of the PSFCH communications to be transmitted on that carrier. The mobile station may select a number of carriers, of the plurality of carriers, based at least in part on the respective priority determined for each carrier of the plurality of carriers. The mobile station may transmit, in the one or more PSFCH symbols, PSFCH communications on the number of carriers selected. As a result, the mobile station may prioritize the PSFCH communications scheduled to be transmitted by the mobile station in the one or more PSFCH symbols. In some aspects, the number of carriers selected by the mobile station may be based at least in part on a capability of the mobile station for simultaneous PSFCH transmissions on multiple carriers, which may prevent the number of simultaneous PSFCH transmissions on different carriers from exceeding the capability of the mobile station.

Some techniques and apparatuses described herein enable a mobile station (e.g., a UE) to determine a respective priority, for each carrier of a plurality of carriers on which a plurality of PSFCH communications are to be received in one or more PSFCH symbols, based at least in part on priorities of the PSFCH communications to be received on that carrier. The mobile station may select a number of carriers, of the plurality of carriers, based at least in part on the respective priority determined for each carrier of the plurality of carriers. The mobile station may receive, in the one or more PSFCH symbols, PSFCH communications on the number of carriers selected. As a result, the mobile station may prioritize the PSFCH communications scheduled to be received by the mobile station in the one or more PSFCH symbols. In some aspects, the number of carriers selected by the mobile station may be based at least in part on a capability of the mobile station for simultaneous PSFCH receptions on multiple carriers, which may prevent the number of simultaneous PSFCH receptions on different carriers from exceeding the capability of the mobile station.

Some techniques and apparatuses described herein enable a mobile station (e.g., a UE) to determine a transmission priority for one or more PSFCH symbols based at least in part on first carrier priorities for a first set of carriers on which a first set of PSFCH communications are to be transmitted in the one or more PSFCH symbols. The mobile station may determine a reception priority for the one or more PSFCH symbols based at least in part on second carrier priorities for a second set of carriers on which a second set of PSFCH communications are to be received in the one or more PSFCH symbols. The mobile station may selectively transmit the first set of PSFCH communications on the first set of carriers or receive the second set of PSFCH communications on the second set of carriers in the one or more PSFCH symbols, based at least in part on the transmission priority and the reception priority. As a result, the mobile station may prioritize whether to transmit or receive PSFCH communications in the one or more PSFCH symbols.

FIG. 7 is a diagram illustrating an example 700 associated with prioritizing PSFCH communications in carrier aggregation and multiple carrier operation, in accordance with the present disclosure. As shown in FIG. 7, example 700 includes a network node 110, a first UE 120-1, and one or more second UEs 120-2. In some aspects, the UEs 120 (e.g., the first UE 120-1 and the second UEs 120-2) may be mobile stations, may include mobile stations, or may be included in mobile stations.

As shown in FIG. 7, and by reference number 705, in some aspects, the first UE 120-1 may transmit, to the one or more second UEs 120-2 and/or to the network node 110, a UE capability report that indicates a UE capability for simultaneous transmission of PSFCH communications on multiple carriers. In some aspects, the UE capability report may include an indication of a number (N) of carriers on which the first UE 120-1 is capable of simultaneous transmission of PSFCH communications. For example, the first UE 120-1 may be capable of simultaneously transmitting PSFCH communications on N carriers out of M total carriers for sidelink communications. In some aspects, N=1. In this case, the first UE 120-1 may be capable of transmitting PSFCH communications on one carrier in a PSFCH symbol. In some aspects, the first UE 120-1 may be capable of simultaneous transmission of PSFCH communications on a number of carriers that is greater than 1 (e.g., N>1).

In some aspects, the UE capability report may indicate a capability of the first UE 120-1 for simultaneous transmission of PSFCH communications on adjacent carriers. For example, the UE capability report may indicate whether or not the first UE 120-1 is capable of simultaneous transmission of PSFCH communications on adjacent carriers. In some aspects, the UE capability report may indicate a UE capability for a total number of simultaneous PSFCH transmissions. For example, the UE capability report may indicate a maximum quantity of simultaneous transmissions of PSFCH communications per carrier, for the first UE 120-1. Additionally, or alternatively, the UE capability report may indicate a maximum quantity of total simultaneous transmissions of PSFCH communications on all N carriers, for the first UE 120-1.

In some aspects, the first UE 120-1 may transmit the UE capability report to one or more second UEs 120-2. In some aspects, the first UE 120-1 may transmit the UE capability report to a second UE 120-2 in a PC5 RRC message. For example, the first UE 120-1 and each second UE 120-2 may exchange capability reports, that indicate the UE capabilities for simultaneous transmission of PSFCH communications on multiple carriers and/or UE capabilities for simultaneous reception of PSFCH communications on multiple carriers, during establishment of a PC5 connection between the first UE 120-1 and each second UE 120-2.

In some aspects, the first UE 120-1 may transmit the UE capability report to the network node 110. In some aspects, the network node 110 may perform testing of the first UE 120-1 and/or configuration of the first UE 120-1 based at least in part on the capability information indicated in the UE capability report.

As further shown in FIG. 7, and by reference number 710, the first UE 120-1 may receive one or more sidelink communications from the one or more second UEs 120-2. The one or more second UEs 120-2 may transmit one or more sidelink communications to the first UE 120-1 in sidelink resources allocated in sidelink resource pools (e.g., via Mode 1 or Mode 2 sidelink resource allocation). In some aspects, the first UE 120-1 may receive the sidelink communications (e.g., PSSCH communications) in PSSCH resources in one or more slots, on multiple carriers.

Each sidelink communication (e.g., PSSCH communication) received by the first UE 120-1 may map to a respective PSFCH resource, in a PSFCH symbol or in multiple (e.g., 2) PSFCH symbols, to be used by the first UE 120-1 to transmit feedback (e.g., HARQ ACK/NACK feedback) for the sidelink communication. In some aspects, in connection with receiving the sidelink communications, a plurality of PSFCH communications may be scheduled, to be transmitted by the first UE 120-1 in one or more PSFCH symbols. In some aspects, the plurality of PSFCH communications scheduled to be transmitted by the first UE 120-1 in the one or more PSFCH symbols may include one or more PSFCH communications on each carrier of a plurality of carriers. In some aspects, the PSFCH communications scheduled to be transmitted by the first UE 120-1 in the one or more PSFCH symbols may include one or more HARQ ACK/NACK PSFCH communications (e.g., for the sidelink communications received by the first UE 120-1) and/or one or more pre-collision PSFCH communications. A pre-collision PSFCH communication may be a PSFCH communication that includes an indication that scheduled resources, indicated in SCI received by the first UE 120-1, for a sidelink communication overlap with resources already allocated for a sidelink communication scheduled by another UE. In some aspects, the first UE 120-1 may allocate PSFCH resources for one or more pre-collision PSFCH communications based at least in part on detecting a potential collision in resources scheduled by SCI received by the first UE 120-1.

As further shown in FIG. 7, and by reference number 715, the first UE 120-1 may determine carrier priorities for the plurality of carriers on which PSFCH communications are to be transmitted in one or more PSFCH symbols. In some aspects, the first UE 120-1 may determine a respective carrier priority for each carrier of the plurality of carriers on which PSFCH communications are scheduled to be transmitted, by the first UE 120-1, in the one or more PSFCH symbols. Each carrier, of the plurality of carriers on which PSFCH communications are to be transmitted in the one or more PSFCH symbols, may include one or more PSFCH communications scheduled to be transmitted on that carrier. For each carrier, the first UE 120-1 may determine priorities for the PSFCH communications to be transmitted on that carrier. For example, the first UE 120-1 may determine the priority for each HARQ ACK/NACK PSFCH communication to be transmitted on the carrier based at least in part on a priority of the sidelink communication (e.g., PSSCH communication) for which the HARQ ACK/NACK feedback is being provided by the first UE 120-1. The first UE 120-1 may determine the priority for each pre-collision communication to be transmitted on the carrier based at least in part on the priority of the PSSCH communication scheduled by the SCI that triggers the pre-collision communication (or based at least in part on the priority of the already-scheduled PSSCH communication).

In some aspects, the first UE 120-1 may determine the respective carrier priority for each carrier, of the plurality of carriers on which the PSFCH communications are to be transmitted in the one or more PSFCH symbols, based at least in part on the priorities of the PSFCH communications to be transmitted on that carrier. For example, the first UE 120-1 may determine the priority, for each carrier, to be a highest PSFCH priority among the PSFCH communications to be transmitted on that carrier. In some aspects, the first UE 120-1 may prioritize carriers on which the PSFCH communications to be transmitted include only HARQ ACK/NACK PSFCH communications, over carriers on which the PSFCH communications to be transmitted include one or more pre-collision PSFCH communications. For example, the first UE 120-1 may determine the respective priority for each carrier, for which the PSFCH communications to be transmitted on that carrier include only HARQ ACK/NACK PSFCH communications, to be higher than the respective priority for each carrier, for which the PSFCH communications to be transmitted on that carrier include only pre-collision PSFCH communications.

In some aspects, in a case in which the PSFCH communications to be transmitted on a carrier include both one or more HARQ ACK/NACK PSFCH communications and one or more pre-collision PSFCH communications, the first UE 120-1 may determine that the carrier priority for that carrier is the highest priority of the one or more HARQ ACK/NACK PSFCH communications to be transmitted on that carrier (e.g., ignoring the priorities of the one or more pre-collision PSFCH communications to be transmitted on that carrier). In some aspects, in a case in which the PSFCH communications to be transmitted on a carrier include both one or more HARQ ACK/NACK PSFCH communications and one or more pre-collision PSFCH communications, the first UE 120-1 may determine that the carrier priority for that carrier is the highest priority of the one or more HARQ ACK/NACK PSFCH communications and the one or more pre-collision PSFCH communications to be transmitted on that carrier.

As further shown in FIG. 7, and by reference number 720, the first UE 120-1 may select a number of carriers, of the plurality of carriers on which PSFCH communications are to be transmitted in the one or more PSFCH symbols, based at least in part on the respective carrier priority determined for each carrier. In some aspects, the first UE 120-1 may select N carriers, of the plurality of carriers on which PSFCH communications are to be transmitted in the one or more PSFCH symbols. In this case, N may be the number of carriers on which the UE is capable of simultaneous transmission of PSFCH communications. For example, the first UE 120-1 may select N carriers with the highest carrier priorities.

As further shown in FIG. 7, and by reference number 725, the first UE 120-1 may transmit, in the one or more PSFCH symbols, to one or more of the second UEs 120-2, PSFCH communications on the selected N carriers. The PSFCH communications, transmitted by the first UE 120-1 in the one or more PSFCH symbols on the selected N carriers, may include one or more HARQ ACK/NACK PSFCH communications for the one or more sidelink communications (e.g., PSSCH communications) received by the first UE 120-1 and/or one or more pre-collision PSFCH communications.

In some aspects, a UE capability for the first UE 120-1 may include a maximum number of simultaneous transmissions of PSFCH communications per carrier. In this case, the quantity of PSFCH communications transmitted by the first UE 120-1 in the one or more PSFCH symbols on each carrier, of the N selected carriers, may be based at least in part on the maximum number of simultaneous transmissions of PSFCH communications per carrier. For example, the first UE 120-1 may drop one or more lowest priority PSFCH communications on a carrier, in a case in which the number of PSFCH communications to be transmitted on that carrier, in the one or more PSFCH symbols, exceeds the maximum number of simultaneous transmissions of PSFCH communications per carrier.

In some aspects, a UE capability for the first UE 120-1 may include a maximum total number of simultaneous transmissions of PSFCH communications on all N carriers. In this case, the first UE 120-1 may drop one or more lowest priority PSFCH communications to be transmitted, in the one or more PSFCH symbols, on at least one carrier of the N selected carriers, to meet the maximum total number of simultaneous transmissions of PSFCH communications over all N selected carriers.

As described above, the first UE 120-1 may determine a respective priority, for each carrier of a plurality of carriers on which a plurality of PSFCH communications are to be transmitted in one or more PSFCH symbols, based at least in part on priorities of the PSFCH communications to be transmitted on that carrier. The first UE 120-1 may select N carriers, of the plurality of carriers, based at least in part on the respective priority determined for each carrier of the plurality of carriers. The first UE 120-1 may transmit, in the one or more PSFCH symbols, PSFCH communications on the N carriers selected. As a result, the first UE 120-1 may prioritize the PSFCH communications scheduled to be transmitted by the mobile station in the one or more PSFCH symbols. In some aspects, the number (N) of carriers selected by the first UE 120-1 may be based at least in part on a capability of the first UE 120-1 for simultaneous PSFCH transmissions on multiple carriers, which may prevent the number of simultaneous PSFCH transmissions on different carriers from exceeding the capability of the first UE 120-1.

As indicated above, FIG. 7 is provided as an example. Other examples may differ from what is described with respect to FIG. 7.

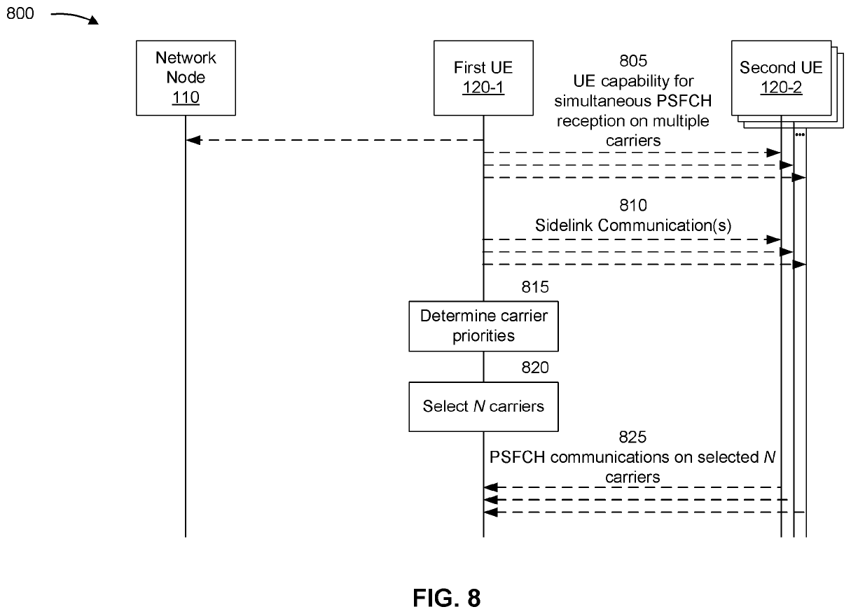

FIG. 8 is a diagram illustrating an example 800 associated with prioritizing PSFCH communications in carrier aggregation and multiple carrier operation, in accordance with the present disclosure. As shown in FIG. 8, example 800 includes a network node 110, a first UE 120-1, and one or more second UEs 120-2. In some aspects, the UEs 120 (e.g., the first UE 120-1 and the second UEs 120-2) may be mobile stations, may include mobile stations, or may be included in mobile stations.

As shown in FIG. 8, and by reference number 805, in some aspects, the first UE 120-1 may transmit, to the one or more second UEs 120-2 and/or to the network node 110, a UE capability report that indicates a UE capability for simultaneous reception of PSFCH communications on multiple carriers. In some aspects, the UE capability report may include an indication of a number (N) of carriers on which the first UE 120-1 is capable of simultaneous reception of PSFCH communications. For example, the first UE 120-1 may be capable of simultaneously receiving PSFCH communications on N carriers out of M total carriers for sidelink communications. In some aspects, N=1. In this case, the first UE 120-1 may be capable of receiving PSFCH communications on one carrier in a PSFCH symbol. In some aspects, the first UE 120-1 may be capable of simultaneous reception of PSFCH communications on a number of carriers that is greater than 1 (e.g., N>1).

In some aspects, the UE capability report may indicate a capability of the first UE 120-1 for simultaneous reception of PSFCH communications on adjacent carriers. For example, the UE capability report may indicate whether or not the first UE 120-1 is capable of simultaneous reception of PSFCH communications on adjacent carriers. In some aspects, the UE capability report may indicate a UE capability for a total number of simultaneous PSFCH receptions. For example, the UE capability report may indicate a maximum quantity of simultaneous receptions of PSFCH communications per carrier, for the first UE 120-1. Additionally, or alternatively, the UE capability report may indicate a maximum quantity of total simultaneous receptions of PSFCH communications on all N carriers, for the first UE 120-1.

In some aspects, the first UE 120-1 may transmit the UE capability report to one or more second UEs 120-2. In some aspects, the first UE 120-1 may transmit the UE capability report to a second UE 120-2 in a PC5 RRC message. For example, the first UE 120-1 and each second UE 120-2 may exchange capability reports, that indicate the UE capabilities for simultaneous reception of PSFCH communications on multiple carriers and/or UE capabilities for simultaneous transmission of PSFCH communications on multiple carriers, during establishment of a PC5 connection between the first UE 120-1 and each second UE 120-2.

In some aspects, the first UE 120-1 may transmit the UE capability report to the network node 110. In some aspects, the network node 110 may perform testing of the first UE 120-1 and/or configuration of the first UE 120-1 based at least in part on the capability information indicated in the UE capability report.

As further shown in FIG. 8, and by reference number 810, the first UE 120-1 may transmit one or more sidelink communications to the one or more second UEs 120-2. For example, the first UE 120-1 may transmit the one or more sidelink communications to the one or more second UEs 120-2 in sidelink resources allocated in sidelink resource pools (e.g., via Mode 1 or Mode 2 sidelink resource allocation). The one or more second UEs 120-2 may receive the sidelink communications transmitted by the first UE 120-1. In some aspects, the sidelink communications may include PSSCH communications and SCI scheduling the PSSCH communications. In some aspects, the first UE 120-1 may transmit the sidelink communications (e.g., PSSCH communications) in PSSCH resources in one or more slots, on multiple carriers.

Each sidelink communication (e.g., PSSCH communication) transmitted by the first UE 120-1 may map to a respective PSFCH resource, in a PSFCH symbol or in multiple (e.g., 2) PSFCH symbols, to be used by the second UE 120-2 that receives the sidelink communication to transmit feedback (e.g., HARQ ACK/NACK feedback) for the sidelink communication. In some aspects, in connection with transmitting the sidelink communications, a plurality of PSFCH communications may be scheduled to be received by the first UE 120-1 (e.g., from the one or more second UEs 120-2) in one or more PSFCH symbols. In some aspects, the plurality of PSFCH communications scheduled to be received by the first UE 120-1 in the one or more PSFCH symbols may include one or more PSFCH communications on each carrier of a plurality of carriers. In some aspects, the PSFCH communications scheduled to be received by the first UE 120-1 in the one or more PSFCH symbols (e.g., to be monitored for by the first UE 120-1 in the one or more PSFCH symbols) may include one or more HARQ ACK/NACK PSFCH communications (e.g., for the sidelink communications transmitted by the first UE 120-1) and/or one or more pre-collision PSFCH communications.

As further shown in FIG. 8, and by reference number 815, the first UE 120-1 may determine carrier priorities for the plurality of carriers on which PSFCH communications are to be received in one or more PSFCH symbols. In some aspects, the first UE 120-1 may determine a respective carrier priority for each carrier of the plurality of carriers on which PSFCH communications are scheduled to be received, by the first UE 120-1, in the one or more PSFCH symbols. Each carrier, of the plurality of carriers on which PSFCH communications are to be received in the one or more PSFCH symbols, may include one or more PSFCH communications scheduled to be received on that carrier. For each carrier, the first UE 120-1 may determine priorities for the PSFCH communications to be received (e.g., monitored for) on that carrier. For example, the first UE 120-1 may determine the priority for each HARQ ACK/NACK PSFCH communication to be received on the carrier based at least in part on a priority of the sidelink communication (e.g., PSSCH communication) for which the HARQ ACK/NACK feedback is to be provided to the first UE 120-1. The first UE 120-1 may determine the priority for each pre-collision communication to be received (e.g., monitored for) on the carrier based at least in part on the priority of the PSSCH communication scheduled by the SCI that triggers the pre-collision communication.

In some aspects, the first UE 120-1 may determine the respective carrier priority for each carrier, of the plurality of carriers on which the PSFCH communications are to be received in the one or more PSFCH symbols, based at least in part on the priorities of the PSFCH communications to be received on that carrier. For example, the first UE 120-1 may determine the priority, for each carrier, to be a highest PSFCH priority among the PSFCH communications to be received on that carrier. In some aspects, the first UE 120-1 may prioritize carriers on which the PSFCH communications to be received include only HARQ ACK/NACK PSFCH communications over carriers on which the PSFCH communications to be received include one or more pre-collision PSFCH communications. For example, the first UE 120-1 may determine the respective priority for each carrier, for which the PSFCH communications to be received on that carrier include only HARQ ACK/NACK PSFCH communications, to be higher than the respective priority for each carrier, for which the PSFCH communications to be received on that carrier include only pre-collision PSFCH communications.

In some aspects, in a case in which the PSFCH communications to be received on a carrier include both one or more HARQ ACK/NACK PSFCH communications and one or more pre-collision PSFCH communications, the first UE 120-1 may determine that the carrier priority for that carrier is the highest priority of the one or more HARQ ACK/NACK PSFCH communications to be received on that carrier (e.g., ignoring the priorities of the one or more pre-collision PSFCH communications to be received on that carrier). In some aspects, in a case in which the PSFCH communications to be received on a carrier include both one or more HARQ ACK/NACK PSFCH communications and one or more pre-collision PSFCH communications, the first UE 120-1 may determine that the carrier priority for that carrier is the highest priority of the one or more HARQ ACK/NACK PSFCH communications and the one or more pre-collision PSFCH communications to be received on that carrier.

As further shown in FIG. 8, and by reference number 820, the first UE 120-1 may select a number of carriers, of the plurality of carriers on which PSFCH communications are to be received in the one or more PSFCH symbols, based at least in part on the respective carrier priority determined for each carrier. In some aspects, the first UE 120-1 may select N carriers, of the plurality of carriers on which PSFCH communications are to be received in the one or more PSFCH symbols. In this case, N may be the number of carriers on which the UE is capable of simultaneous reception of PSFCH communications. For example, the first UE 120-1 may select N carriers with the highest carrier priorities.

As further shown in FIG. 8, and by reference number 825, the first UE 120-1 may receive, in the one or more PSFCH symbols, from one or more of the second UEs 120-2, PSFCH communications on the selected N carriers. The PSFCH communications, received by the first UE 120-1 in the one or more PSFCH symbols on the selected N carriers, may include one or more HARQ ACK/NACK PSFCH communications for the one or more sidelink communications (e.g., PSSCH communications) transmitted by the first UE 120-1 and/or one or more pre-collision PSFCH communications.

In some aspects, a UE capability for the first UE 120-1 may include a maximum number of simultaneous receptions of PSFCH communications per carrier. In this case, the quantity of PSFCH communications received by the first UE 120-1 in the one or more PSFCH symbols on each carrier, of the N selected carriers, may be based at least in part on the maximum number of simultaneous receptions of PSFCH communications per carrier. For example, the first UE 120-1 may drop one or more lowest priority PSFCH communications on a carrier, in a case in which the number of PSFCH communications to be received on that carrier, in the one or more PSFCH symbols, exceeds the maximum number of simultaneous receptions of PSFCH communications per carrier.

In some aspects, a UE capability for the first UE 120-1 may include a maximum total number of simultaneous receptions of PSFCH communications on all N carriers. In this case, the first UE 120-1 may drop one or more lowest priority PSFCH communications to be received, in the one or more PSFCH symbols, on at least one carrier of the N selected carriers, to meet the maximum total number of simultaneous receptions of PSFCH communications over all N selected carriers.

As described above, the first UE 120-1 may determine a respective priority, for each carrier of a plurality of carriers on which a plurality of PSFCH communications are to be received in one or more PSFCH symbols, based at least in part on priorities of the PSFCH communications to be received on that carrier. The first UE 120-1 may select N carriers, of the plurality of carriers, based at least in part on the respective priority determined for each carrier of the plurality of carriers. The first UE 120-1 may receive, in the one or more PSFCH symbols, PSFCH communications on the N carriers selected. As a result, the first UE 120-1 may prioritize the PSFCH communications scheduled to be received by the mobile station in the one or more PSFCH symbols. In some aspects, the number (N) of carriers selected by the first UE 120-1 may be based at least in part on a capability of the first UE 120-1 for simultaneous PSFCH receptions on multiple carriers, which may prevent the number of simultaneous PSFCH receptions on different carriers from exceeding the capability of the first UE 120-1.

As indicated above, FIG. 8 is provided as an example. Other examples may differ from what is described with respect to FIG. 8.

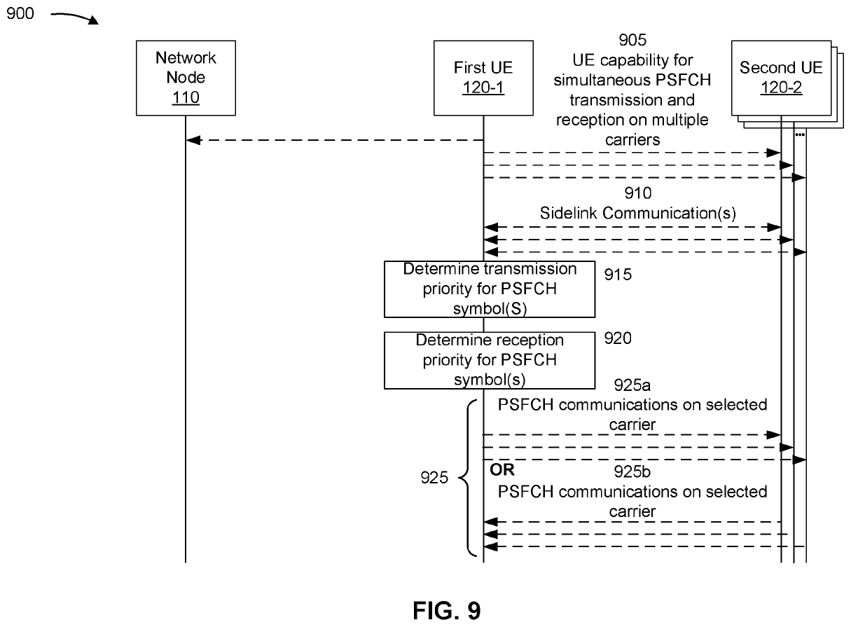

FIG. 9 is a diagram illustrating an example 900 associated with prioritizing PSFCH communications in carrier aggregation and multiple carrier operation, in accordance with the present disclosure. As shown in FIG. 9, example 900 includes a network node 110, a first UE 120-1, and one or more second UEs 120-2. In some aspects, the UEs 120 (e.g., the first UE 120-1 and the second UEs 120-2) may be mobile stations, may include mobile stations, or may be included in mobile stations.

As shown in FIG. 9, and by reference number 905, in some aspects, the first UE 120-1 may transmit, to the one or more second UEs 120-2 and/or to the network node 110, a UE capability report that indicates a UE capability for simultaneous transmission of PSFCH communications on multiple carriers and a UE capability for simultaneous reception of PSFCH communications on multiple carriers.

In some aspects, the UE capability report may include an indication of a number (N_{Tx}) of carriers on which the first UE 120-1 is capable of simultaneous transmission of PSFCH communications. For example, the first UE 120-1 may be capable of simultaneously transmitting PSFCH communications on N_{Tx} carriers out of M total carriers for sidelink communications. In some aspects, N_{Tx}=1. In this case, the first UE 120-1 may be capable of transmitting PSFCH communications on one carrier in a PSFCH symbol. In some aspects, the first UE 120-1 may be capable of simultaneous transmission of PSFCH communications on a number of carriers that is greater than 1 (e.g., N_{Tx}>1).

In some aspects, the UE capability report may indicate a capability of the first UE 120-1 for simultaneous transmission of PSFCH communications on adjacent carriers. For example, the UE capability report may indicate whether or not the first UE 120-1 is capable of simultaneous transmission of PSFCH communications on adjacent carriers. In some aspects, the UE capability report may indicate a UE capability for a total number of simultaneous PSFCH transmissions. For example, the UE capability report may indicate a maximum quantity of simultaneous transmissions of PSFCH communications per carrier, for the first UE 120-1. Additionally, or alternatively, the UE capability report may indicate a maximum quantity of total simultaneous transmissions of PSFCH communications on all N_{Tx} carriers, for the first UE 120-1.

In some aspects, the UE capability report may include an indication of a number (N_{Rx}) of carriers on which the first UE 120-1 is capable of simultaneous reception of PSFCH communications. For example, the first UE 120-1 may be capable of simultaneously receiving PSFCH communications on N_{Rx} carriers out of M total carriers for sidelink communications. In some aspects, N_{Rx}=1. In this case, the first UE 120-1 may be capable of receiving PSFCH communications on one carrier in a PSFCH symbol. In some aspects, the first UE 120-1 may be capable of simultaneous reception of PSFCH communications on a number of carriers that is greater than 1 (e.g., N_{Rx}>1). In some aspects, the capability of the first UE 120-1 for simultaneous transmission on multiple carriers may be the same as the capability of the first UE 120-1 for simultaneous reception on multiple carriers (e.g., N_{Tx}=N_{Rx}). In some aspects, the capability of the first UE 120-1 for simultaneous transmission on multiple carriers may be the different from the capability of the first UE 120-1 for simultaneous reception on multiple carriers.

In some aspects, the UE capability report may indicate a capability of the first UE 120-1 for simultaneous reception of PSFCH communications on adjacent carriers. For example, the UE capability report may indicate whether or not the first UE 120-1 is capable of simultaneous reception of PSFCH communications on adjacent carriers. In some aspects, the UE capability report may indicate a UE capability for a total number of simultaneous PSFCH receptions. For example, the UE capability report may indicate a maximum quantity of simultaneous receptions of PSFCH communications per carrier, for the first UE 120-1. Additionally, or alternatively, the UE capability report may indicate a maximum quantity of total simultaneous receptions of PSFCH communications on all N_{Rx} carriers, for the first UE 120-1.

In some aspects, the first UE 120-1 may transmit the UE capability report to one or more second UEs 120-2. In some aspects, the first UE 120-1 may transmit the UE capability report to a second UE 120-2 in a PC5 RRC message. For example, the first UE 120-1 and each second UE 120-2 may exchange capability reports, that indicate the UE capabilities for simultaneous transmission and reception of PSFCH communications on multiple carriers, during establishment of a PC5 connection between the first UE 120-1 and each second UE 120-2.

In some aspects, the first UE 120-1 may transmit the UE capability report to the network node 110. In some aspects, the network node 110 may perform testing of the first UE 120-1 and/or configuration of the first UE 120-1 based at least in part on the capability information indicated in the UE capability report.

As further shown in FIG. 9, and by reference number 910, the first UE 120-1 may transmit one or more sidelink communications to one or more second UEs 120-2, and the first UE 120-1 may receive one or more sidelink communications from one or more second UEs 120-2. In some aspects, the first UE 120-1 may transmit one or more sidelink communications in PSSCH resources in one or more slots, on multiple carriers, and the first UE 120-1 may receive one or more sidelink communications (e.g., PSSCH communications) in PSSCH resources in one or more slots, on multiple carriers.

Each sidelink communication (e.g., PSSCH communication) received by the first UE 120-1 may map to a respective PSFCH resource, in a PSFCH symbol or in multiple (e.g., 2) PDFCH symbols, to be used by the first UE 120-1 to transmit feedback (e.g., HARQ ACK/NACK feedback) for the sidelink communication. In some aspects, in connection with receiving one or more sidelink communications, a first set of PSFCH communications may be scheduled to be transmitted by the first UE 120-1 in one or more PSFCH symbols. In some aspects, the first set of PSFCH communications scheduled to be transmitted by the first UE 120-1 in the one or more PSFCH symbols may include one or more PSFCH communications on each carrier of a first set of carriers. For example, the first set of carriers may include one or more carriers. In some aspects, the first set of PSFCH communications scheduled to be transmitted by the first UE 120-1 in the one or more PSFCH symbols may include one or more HARQ ACK/NACK PSFCH communications (e.g., for the sidelink communications received by the first UE 120-1) and/or one or more pre-collision PSFCH communications.

Each sidelink communication (e.g., PSSCH communication) transmitted by the first UE 120-1 may map to a respective PSFCH resource, in a PSFCH symbol or in multiple (e.g., 2) PSFCH symbols, to be monitored by the first UE 120-1 to receive feedback (e.g., HARQ ACK/NACK feedback) for the sidelink communication. In some aspects, in connection with transmitting one or more sidelink communications, a second set of PSFCH communications may be scheduled to be received (e.g., monitored for) by the first UE 120-1 in the one or more PSFCH symbols. In some aspects, the second set of PSFCH communications scheduled to be received by the first UE 120-1 in the one or more PSFCH symbols may include one or more PSFCH communications on each carrier of a second set of carriers. For example, the second set of carriers may include one or more carriers. In some aspects, the second set of PSFCH communications scheduled to be received by the first UE 120-1 in the one or more PSFCH symbols may include one or more HARQ ACK/NACK PSFCH communications (e.g., for the sidelink communications transmitted by the first UE 120-1) and/or one or more pre-collision PSFCH communications.

As further shown in FIG. 9, and by reference number 915, the first UE 120-1 may determine a transmission priority for the one or more PSFCH symbols. In some aspects, the first UE 120-1 may determine the transmission priority based at least in part on carrier priorities (e.g., first carrier priorities) for the first set of carriers on which the first set of PSFCH communications are scheduled to be transmitted, by the first UE 120-1, in the one or more PSFCH symbols. In some aspects, the first UE 120-1 may determine respective carrier priorities for the first set of carriers, and the UE may select N_{Tx} carriers (e.g., up to N_{Tx} carriers) from the first set of carriers, as described above in connection with FIG. 7. In some aspects, the first UE 120-1 may then determine the transmission priority for the one or more PSFCH symbols as the highest carrier priority among the N_{Tx} carriers (e.g., the highest carrier priority in the first set of carriers).

In some aspects, in a case in which one or more HARQ ACK/NACK PSFCH communications and one or more pre-collision PSFCH communications are scheduled to be transmitted on the carrier with the highest carrier priority, among the N_{Tx} carriers, the transmission priority for the one or more PSFCH symbols may be the highest priority of the one or more HARQ ACK/NACK PSFCH communications to be transmitted on that carrier (e.g., ignoring the priorities of the one or more pre-collision PSFCH communications to be transmitted on that carrier). In some aspects, in a case in which one or more HARQ ACK/NACK PSFCH communications and one or more pre-collision PSFCH communications are scheduled to be transmitted on the carrier with the highest carrier priority, among the N_{Tx} carriers, the transmission priority for the one or more PSFCH symbols may be the highest priority of the one or more HARQ ACK/NACK PSFCH communications and the one or more pre-collision PSFCH communications to be transmitted on that carrier.

As further shown in FIG. 9, and by reference number 920, the first UE 120-1 may determine a reception priority for the one or more PSFCH symbols. In some aspects, the first UE 120-1 may determine the reception priority based at least in part on carrier priorities (e.g., second carrier priorities) for the second set of carriers on which the second set of PSFCH communications are scheduled to be received, by the first UE 120-1, in the one or more PSFCH symbols. In some aspects, the first UE 120-1 may determine respective carrier priorities for the second set of carriers, and the UE may select N_{Rx} carriers (e.g., up to N_{Rx} carriers) from the second set of carriers, as described above in connection with FIG. 8. In some aspects, the first UE 120-1 may then determine the reception priority for the one or more PSFCH symbols as the highest carrier priority among the N_{Rx} carriers (e.g., the highest carrier priority in the second set of carriers).

In some aspects, in a case in which one or more HARQ ACK/NACK PSFCH communications and one or more pre-collision PSFCH communications are scheduled to be received on the carrier with the highest carrier priority, among the N_{Rx} carriers, the transmission priority for the one or more PSFCH symbols may be the highest priority of the one or more HARQ ACK/NACK PSFCH communications to be received on that carrier (e.g., ignoring the priorities of the one or more pre-collision PSFCH communications to be received on that carrier). In some aspects, in a case in which one or more HARQ ACK/NACK PSFCH communications and one or more pre-collision PSFCH communications are scheduled to be received on the carrier with the highest carrier priority, among the N_{Rx} carriers, the transmission priority for the one or more PSFCH symbols may be the highest priority of the one or more HARQ ACK/NACK PSFCH communications and the one or more pre-collision PSFCH communications to be received on that carrier.

In some aspects, in a case in which one of the transmission priority or the reception priority is a priority of a carrier on which only one or more HARQ ACK/NACK PSFCH communications are scheduled in the one or more PSFCH symbols, and the other one of the transmission priority or the reception priority is a priority of a carrier on which only pre-collision PSFCH communications are scheduled, the first UE 120-1 may determine the one of the transmission priority or the reception priority that is based on the carrier on which only the HARQ ACK/NACK PSFCH communications are scheduled, to be higher than the other one of the transmission priority or the reception priority that is based on the carrier on which only pre-collision PSFCH communications are scheduled.

As further shown in FIG. 9, and by reference number 925, the first UE 120-1 may selectively transmit PSFCH communications or receive PSFCH communications in the one or more PSFCH symbols based at least in part on the transmission priority determined for the one or more PSFCH symbols and the reception priority determined for the one or more PSFCH symbols. In some aspects, the first UE 120-1 may compare the transmission priority determined for the one or more PSFCH symbols and the reception priority determined for the one or more PSFCH symbols. In a case in which the transmission priority is higher than the reception priority, the first UE 120-1 may transmit PSFCH communications in the one or more PSFCH symbols. In a case in which the reception priority is higher than the transmission priority, the first UE 120-1 may receive PSFCH communications in the one or more PSFCH symbols.

As shown by reference number 925a, in some aspects, in connection with a determination that the transmission priority for the one or more PSFCH symbols is higher than the reception priority for the one or more PSFCH symbols, the first UE 120-1 may transmit, in the one or more PSFCH symbols, to one or more second UEs 120-2, PSFCH communications (e.g., all or a subset of the first set of PSFCH communications) on the N_{Tx} carriers selected from the first set of carriers.

As shown by reference number 925b, in some aspects, in connection with a determination that the reception priority for the one or more PSFCH symbols is higher than the transmission priority for the one or more PSFCH symbols, the first UE 120-1 may receive, in the one or more PSFCH symbols, from one or more second UEs 120-2, PSFCH communications (e.g., all or a subset of the second set of PSFCH communications) on the N_{Rx} carriers selected from the second set of carriers.

In some aspects, once the prioritization of PSFCH transmission or PSFCH reception is performed for one or more PSFCH symbols, as described above in connection with FIG. 9, the first UE 120-1 may then perform a prioritization procedure to determine whether to prioritize the PSFCH transmission or reception, uplink transmission, or LTE sidelink transmission or reception.

As described above, the first UE 120-1 may determine a transmission priority for one or more PSFCH symbols based at least in part on first carrier priorities for a first set of carriers on which a first set of PSFCH communications are to be transmitted in the one or more PSFCH symbols. The first UE 120-1 may determine a reception priority for the one or more PSFCH symbols based at least in part on second carrier priorities for a second set of carriers on which a second set of PSFCH communications are to be received in the one or more PSFCH symbols. The first UE 120-1 may selectively transmit the first set of PSFCH communications on the first set of carriers or receive the second set of PSFCH communications on the second set of carriers in the one or more PSFCH symbols, based at least in part on the transmission priority and the reception priority. As a result, the first UE 120-1 may prioritize whether to transmit or receive PSFCH communications in the one or more PSFCH symbols.

As indicated above, FIG. 9 is provided as an example. Other examples may differ from what is described with respect to FIG. 9.

FIG. 10 is a diagram illustrating an example process 1000 performed, for example, by a mobile station, in accordance with the present disclosure. Example process 1000 is an example where the mobile station (e.g., UE 120) performs operations associated with prioritizing PSFCH communications in carrier aggregation or multiple carrier operation.

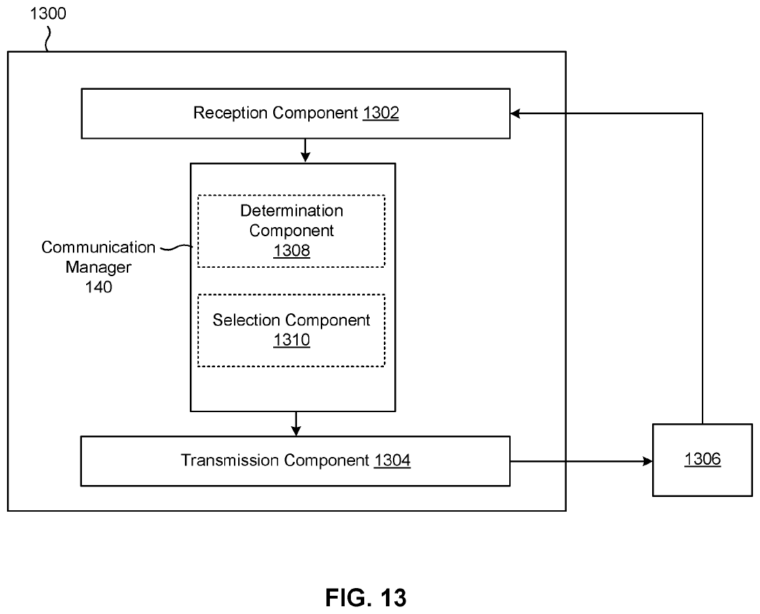

As shown in FIG. 10, in some aspects, process 1000 may include determining a respective priority, for each carrier of a plurality of carriers on which a plurality of PSFCH communications are to be transmitted in one or more PSFCH symbols, based at least in part on priorities of one or more PSFCH communications, of the plurality of PSFCH communications, to be transmitted on that carrier (block 1010). For example, the mobile station (e.g., using communication manager 104 and/or determination component 1308, depicted in FIG. 13) may determine a respective priority, for each carrier of a plurality of carriers on which a plurality of PSFCH communications are to be transmitted in one or more PSFCH symbols, based at least in part on priorities of one or more PSFCH communications, of the plurality of PSFCH communications, to be transmitted on that carrier, as described above.

As further shown in FIG. 10, in some aspects, process 1000 may include selecting a number of carriers, of the plurality of carriers, based at least in part on the respective priority determined for each carrier, of the plurality of carriers (block 1020). For example, the mobile station (e.g., using communication manager 140 and/or selection component 1310, depicted in FIG. 13) may select a number of carriers, of the plurality of carriers, based at least in part on the respective priority determined for each carrier, of the plurality of carriers, as described above.

As further shown in FIG. 10, in some aspects, process 1000 may include transmitting, in the one or more PSFCH symbols, by the mobile station to one or more other mobile stations, PSFCH communications, of the plurality of PSFCH communications, on the number of carriers selected (block 1030). For example, the mobile station (e.g., using communication manager 140 and/or transmission component 1304, depicted in FIG. 13) may transmit, in the one or more PSFCH symbols, by the mobile station to one or more other mobile stations, PSFCH communications, of the plurality of PSFCH communications, on the number of carriers selected, as described above.

Process 1000 may include additional aspects, such as any single aspect or any combination of aspects described below and/or in connection with one or more other processes described elsewhere herein.

In a first aspect, the number of carriers is associated with a capability, of the mobile station, for simultaneous transmission of PSFCH communications on multiple carriers.

In a second aspect, the plurality of PSFCH communications includes one or more HARQ ACK/NACK PSFCH communications and one or more pre-collision PSFCH communications.

In a third aspect, determining the respective priority, for each carrier of the plurality of carriers on which the plurality of PSFCH communications are to be transmitted in the one or more PSFCH symbols, comprises determining the respective priority for each carrier, of the plurality of carriers, for which the one or more PSFCH communications to be transmitted on that carrier include only HARQ ACK/NACK PSFCH communications, to be higher than the respective priority for each carrier, of the plurality of carriers, for which the one or more PSFCH communications to be transmitted on that carrier include only pre-collision PSFCH communications.

In a fourth aspect, determining the respective priority, for each carrier of the plurality of carriers on which the plurality of PSFCH communications are to be transmitted in the one or more PSFCH symbols, comprises determining the respective priority for each carrier, of the plurality of carriers, for which the one or more PSFCH communications to be transmitted on that carrier include at least one HARQ ACK/NACK PSFCH communication and at least one pre-collision PSFCH communication based at least in part on a highest priority associated with the at least one HARQ ACK/NACK PSFCH communication.

In a fifth aspect, determining the respective priority, for each carrier of the plurality of carriers on which the plurality of PSFCH communications are to be transmitted in the one or more PSFCH symbols, comprises determining the respective priority for each carrier, of the plurality of carriers, for which the one or more PSFCH communications to be transmitted on that carrier include at least one HARQ ACK/NACK PSFCH communication and at least one pre-collision PSFCH communication based at least in part on a highest priority associated with the at least one HARQ ACK/NACK PSFCH communication and the at least one pre-collision PSFCH communication.

In a sixth aspect, transmitting the PSFCH communications, of the plurality of PSFCH communications, on the number of carriers selected comprises transmitting, on each carrier of the number of carriers selected, a quantity of the one or more PSFCH communications to be transmitted on that carrier, wherein the quantity is based at least in part on a capability, of the mobile station, for a number of simultaneous transmissions of PSFCH communications per carrier.

In a seventh aspect, transmitting the PSFCH communications, of the plurality of PSFCH communications, on the number of carriers selected comprises dropping one or more lowest priority PSFCH communications, of the one or more PSFCH communications to be transmitted on at least one carrier of the number of carriers selected, based at least in part on a capability, of the mobile station, for a total quantity of simultaneous transmissions of PSFCH communications on the number of carriers.

In an eighth aspect, process 1000 includes transmitting, to at least one of another mobile station or a network node, a capability report that comprises an indication of a capability for a number of carriers for simultaneous transmission of PSFCH communications, and the number of carriers selected corresponds to the capability for the number of carriers for simultaneous transmission of PSFCH communications.

In a ninth aspect, the capability report further comprises an indication of a capability for simultaneous transmission of PSFCH communications on adjacent carriers.

In a tenth aspect, the capability report further comprises an indication of a capability for a number of simultaneous transmissions of PSFCH communications per carrier.

In an eleventh aspect, the capability report further comprises an indication of a capability for a total number of simultaneous transmissions of PSFCH communications on the number of carriers for simultaneous transmission of PSFCH communications.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a mobile station, in accordance with the present disclosure. Example process 1100 is an example where the mobile station (e.g., UE 120) performs operations associated with prioritizing PSFCH communications in carrier aggregation or multiple carrier operation.

As shown in FIG. 11, in some aspects, process 1100 may include determining a respective priority, for each carrier of a plurality of carriers on which a plurality of PSFCH communications are to be received in one or more PSFCH symbols, based at least in part on priorities of one or more PSFCH communications, of the plurality of PSFCH communications, to be received on that carrier (block 1110). For example, the mobile station (e.g., using communication manager 140 and/or determination component 1308, depicted in FIG. 13) may determine a respective priority, for each carrier of a plurality of carriers on which a plurality of PSFCH communications are to be received in one or more PSFCH symbols, based at least in part on priorities of one or more PSFCH communications, of the plurality of PSFCH communications, to be received on that carrier, as described above.

As further shown in FIG. 11, in some aspects, process 1100 may include selecting a number of carriers, of the plurality of carriers, based at least in part on the respective priority determined for each carrier, of the plurality of carriers (block 1120). For example, the mobile station (e.g., using communication manager 140 and/or selection component 1310, depicted in FIG. 13) may select a number of carriers, of the plurality of carriers, based at least in part on the respective priority determined for each carrier, of the plurality of carriers, as described above.

As further shown in FIG. 11, in some aspects, process 1100 may include receiving PSFCH communications, of the plurality of PSFCH communications, on the number of carriers selected (block 1130). For example, the mobile station (e.g., using communication manager 140 and/or reception component 1302, depicted in FIG. 13) may receive PSFCH communications, of the plurality of PSFCH communications, on the number of carriers selected, as described above.

Process 1100 may include additional aspects, such as any single aspect or any combination of aspects described below and/or in connection with one or more other processes described elsewhere herein.

In a first aspect, the number of carriers is associated with a capability, of the mobile station, for simultaneous reception of PSFCH communications on multiple carriers.

In a second aspect, alone or in combination with the first aspect, the plurality of PSFCH communications comprises one or more HARQ ACK/NACK PSFCH communications and one or more pre-collision PSFCH communications.

In a third aspect, alone or in combination with one or more of the first and second aspects, determining the respective priority, for each carrier of the plurality of carriers on which the plurality of PSFCH communications are to be received in the one or more PSFCH symbols, comprises determining the respective priority for each carrier, of the plurality of carriers, for which the one or more PSFCH communications to be received on that carrier comprise only HARQ ACK/NACK PSFCH communications, to be higher than the respective priority for each carrier, of the plurality of carriers, for which the one or more PSFCH communications to be received on that carrier comprise only pre-collision PSFCH communications.

In a fourth aspect, alone or in combination with one or more of the first through third aspects, determining the respective priority, for each carrier of the plurality of carriers on which the plurality of PSFCH communications are to be received in the one or more PSFCH symbols, comprises determining the respective priority for each carrier, of the plurality of carriers, for which the one or more PSFCH communications to be received on that carrier comprise at least one HARQ ACK/NACK PSFCH communication and at least one pre-collision PSFCH communication based at least in part on a highest priority associated with the at least one HARQ ACK/NACK PSFCH communication.

In a fifth aspect, alone or in combination with one or more of the first through fourth aspects, determining the respective priority, for each carrier of the plurality of carriers on which the plurality of PSFCH communications are to be received in the one or more PSFCH symbols, comprises determining the respective priority for each carrier, of the plurality of carriers, for which the one or more PSFCH communications to be received on that carrier comprise at least one HARQ ACK/NACK PSFCH communication and at least one pre-collision PSFCH communication based at least in part on a highest priority associated with the at least one HARQ ACK/NACK PSFCH communication and the at least one pre-collision PSFCH communication.

In a sixth aspect, alone or in combination with one or more of the first through fifth aspects, receiving the PSFCH communications, of the plurality of PSFCH communications, on the number of carriers selected comprises receiving, on each carrier of the number of carriers selected, a quantity of the one or more PSFCH communications to be received on that carrier, wherein the quantity is based at least in part on a capability, of the mobile station, for a number of simultaneous receptions of PSFCH communications per carrier.

In a seventh aspect, alone or in combination with one or more of the first through sixth aspects, receiving the PSFCH communications, of the plurality of PSFCH communications, on the number of carriers selected comprises dropping one or more lowest priority PSFCH communications, of the one or more PSFCH communications to be received on at least one carrier of the number of carriers selected, based at least in part on a capability, of the mobile station, for a total quantity of simultaneous receptions of PSFCH communications on the number of carriers.

In an eighth aspect, alone or in combination with one or more of the first through seventh aspects, process 1100 includes transmitting, to at least one of another mobile station or a network node, a capability report that comprises an indication of a capability for a number of carriers for simultaneous reception of PSFCH communications, and the number of carriers selected corresponds to the capability for the number of carriers for simultaneous reception of PSFCH communications.

In a ninth aspect, alone or in combination with one or more of the first through eighth aspects, the capability report further comprises an indication of a capability for simultaneous reception of PSFCH communications on adjacent carriers.

In a tenth aspect, alone or in combination with one or more of the first through ninth aspects, the capability report further comprises an indication of a capability for a number of simultaneous receptions of PSFCH communications per carrier.

In an eleventh aspect, alone or in combination with one or more of the first through tenth aspects, the capability report further comprises an indication of a capability for a total number of simultaneous receptions of PSFCH communications on the number of carriers for simultaneous reception of PSFCH communications.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a mobile station, in accordance with the present disclosure. Example process 1200 is an example where the mobile station (e.g., UE 120) performs operations associated with prioritizing PSFCH communications in carrier aggregation or multiple carrier operation.

As shown in FIG. 12, in some aspects, process 1200 may include determining a transmission priority for one or more PSFCH symbols based at least in part on first carrier priorities for a first set of carriers on which a first set of PSFCH communications are to be transmitted in the one or more PSFCH symbols (block 1210). For example, the mobile station (e.g., using communication manager 140 and/or determination component 1308, depicted in FIG. 13) may determine a transmission priority for a one or more PSFCH symbols based at least in part on first carrier priorities for a first set of carriers on which a first set of PSFCH communications are to be transmitted in the one or more PSFCH symbols, as described above.

As further shown in FIG. 12, in some aspects, process 1200 may include determining a reception priority for the one or more PSFCH symbols based at least in part on second carrier priorities for a second set of carriers on which a second set of PSFCH communications are to be received in the one or more PSFCH symbols (block 1220). For example, the mobile station (e.g., using communication manager 140 and/or determination component 1308, depicted in FIG. 13) may determine a reception priority for the one or more PSFCH symbols based at least in part on second carrier priorities for a second set of carriers on which a second set of PSFCH communications are to be received in the one or more PSFCH symbols, as described above.

As further shown in FIG. 12, in some aspects, process 1200 may include selectively transmitting the first set of PSFCH communications on the first set of carriers in the one or more PSFCH symbols or receiving the second set of PSFCH communications on the second set of carriers in the one or more PSFCH symbols, based at least in part on the transmission priority and the reception priority (block 1230). For example, the mobile station (e.g., using communication manager 140, selection component 1310, reception component 1302, and/or transmission component 1304, depicted in FIG. 13) may selectively transmit the first set of PSFCH communications on the first set of carriers in the one or more PSFCH symbols or receive the second set of PSFCH communications on the second set of carriers in the one or more PSFCH symbols, based at least in part on the transmission priority and the reception priority, as described above.

Process 1200 may include additional aspects, such as any single aspect or any combination of aspects described below and/or in connection with one or more other processes described elsewhere herein.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a mobile station, or a mobile station may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of a determination component 1308 and/or a selection component 1310, among other examples.

In some aspects, the apparatus 1300 may be configured to perform one or more operations described herein in connection with FIGS. 7-9. Additionally, or alternatively, the apparatus 1300 may be configured to perform one or more processes described herein, such as process 1000 of FIG. 10, process 1100 of FIG. 11, process 1200 of FIG. 12, or a combination thereof. In some aspects, the apparatus 1300 and/or one or more components shown in FIG. 13 may include one or more components of the mobile station described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the mobile station described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the mobile station described in connection with FIG. 2. In some aspects, the transmission component 1304 may be co-located with the reception component 1302 in a transceiver.

The determination component 1308 may determine a respective priority, for each carrier of a plurality of carriers on which a plurality of PSFCH communications are to be transmitted in one or more PSFCH symbols, based at least in part on priorities of one or more PSFCH communications, of the plurality of PSFCH communications, to be transmitted on that carrier. The selection component 1310 may select a number of carriers, of the plurality of carriers, based at least in part on the respective priority determined for each carrier, of the plurality of carriers. The transmission component 1304 may transmit, in the one or more PSFCH symbols, by the mobile station to one or more other mobile stations, PSFCH communications, of the plurality of PSFCH communications, on the number of carriers selected.

The transmission component 1304 may transmit, to at least one of another mobile station or a network node, a capability report that comprises an indication of a capability for a number of carriers for simultaneous transmission of PSFCH communications, wherein the number of carriers selected corresponds to the capability for the number of carriers for simultaneous transmission of PSFCH communications.

The determination component 1308 may determine a respective priority, for each carrier of a plurality of carriers on which a plurality of PSFCH communications are to be received in one or more PSFCH symbols, based at least in part on priorities of one or more PSFCH communications, of the plurality of PSFCH communications, to be received on that carrier. The selection component 1310 may select a number of carriers, of the plurality of carriers, based at least in part on the respective priority determined for each carrier, of the plurality of carriers. The reception component 1302 may receive PSFCH communications, of the plurality of PSFCH communications, on the number of carriers selected.

The transmission component 1304 may transmit, to at least one of another mobile station or a network node, a capability report that comprises an indication of a capability for a number of carriers for simultaneous reception of PSFCH communications, wherein the number of carriers selected corresponds to the capability for the number of carriers for simultaneous reception of PSFCH communications.

The determination component 1308 may determine a transmission priority for one or more PSFCH symbols based at least in part on first carrier priorities for a first set of carriers on which a first set of PSFCH communications are to be transmitted in the one or more PSFCH symbols. The determination component 1308 may determine a reception priority for the one or more PSFCH symbols based at least in part on second carrier priorities for a second set of carriers on which a second set of PSFCH communications are to be received in the one or more PSFCH symbols. The selection component 1310, the reception component 1302, and/or the transmission component 1304 may selectively transmit the first set of PSFCH communications on the first set of carriers in the one or more PSFCH symbols or receive the second set of PSFCH communications on the second set of carriers in the one or more PSFCH symbols, based at least in part on the transmission priority and the reception priority.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a mobile station, comprising: determining, by the mobile station, a respective priority, for each carrier of a plurality of carriers on which a plurality of physical sidelink feedback channel (PSFCH) communications are to be transmitted in one or more PSFCH symbols, based at least in part on priorities of one or more PSFCH communications, of the plurality of PSFCH communications, to be transmitted on that carrier; selecting, by the mobile station, a number of carriers, of the plurality of carriers, based at least in part on the respective priority determined for each carrier, of the plurality of carriers; and transmitting, in the one or more PSFCH symbols, by the mobile station to one or more other mobile stations, PSFCH communications, of the plurality of PSFCH communications, on the number of carriers selected.

Aspect 2: The method of Aspect 1, wherein the number of carriers is associated with a capability, of the mobile station, for simultaneous transmission of PSFCH communications on multiple carriers.

Aspect 3: The method of any of Aspects 1-2, wherein the plurality of PSFCH communications comprises one or more hybrid automated repeat request (HARQ) acknowledgement or negative acknowledgement (ACK/NACK) PSFCH communications and one or more pre-collision PSFCH communications.

Aspect 4: The method of Aspect 3, wherein determining the respective priority, for each carrier of the plurality of carriers on which the plurality of PSFCH communications are to be transmitted in the one or more PSFCH symbols, comprises: determining the respective priority for each carrier, of the plurality of carriers, for which the one or more PSFCH communications to be transmitted on that carrier comprise only HARQ ACK/NACK PSFCH communications, to be higher than the respective priority for each carrier, of the plurality of carriers, for which the one or more PSFCH communications to be transmitted on that carrier comprise only pre-collision PSFCH communications.

Aspect 5: The method of any of Aspects 3-4, wherein determining the respective priority, for each carrier of the plurality of carriers on which the plurality of PSFCH communications are to be transmitted in the one or more PSFCH symbols, comprises: determining the respective priority for each carrier, of the plurality of carriers, for which the one or more PSFCH communications to be transmitted on that carrier comprise at least one HARQ ACK/NACK PSFCH communication and at least one pre-collision PSFCH communication based at least in part on a highest priority associated with the at least one HARQ ACK/NACK PSFCH communication.

Aspect 6: The method of any of Aspects 3-4, wherein determining the respective priority, for each carrier of the plurality of carriers on which the plurality of PSFCH communications are to be transmitted in the one or more PSFCH symbols, comprises: determining the respective priority for each carrier, of the plurality of carriers, for which the one or more PSFCH communications to be transmitted on that carrier comprise at least one HARQ ACK/NACK PSFCH communication and at least one pre-collision PSFCH communication based at least in part on a highest priority associated with the at least one HARQ ACK/NACK PSFCH communication and the at least one pre-collision PSFCH communication.

Aspect 7: The method of any of Aspects 1-6, wherein transmitting the PSFCH communications, of the plurality of PSFCH communications, on the number of carriers selected comprises: transmitting, on each carrier of the number of carriers selected, a quantity of the one or more PSFCH communications to be transmitted on that carrier, wherein the quantity is based at least in part on a capability, of the mobile station, for a number of simultaneous transmissions of PSFCH communications per carrier.

Aspect 8: The method of any of Aspects 1-7, wherein transmitting the PSFCH communications, of the plurality of PSFCH communications, on the number of carriers selected comprises: dropping one or more lowest priority PSFCH communications, of the one or more PSFCH communications to be transmitted on at least one carrier of the number of carriers selected, based at least in part on a capability, of the mobile station, for a total quantity of simultaneous transmissions of PSFCH communications on the number of carriers.

Aspect 9: The method of any of Aspects 1-8, further comprising: transmitting, to at least one of another mobile station or a network node, a capability report that comprises an indication of a capability for a number of carriers for simultaneous transmission of PSFCH communications, wherein the number of carriers selected corresponds to the capability for the number of carriers for simultaneous transmission of PSFCH communications.

Aspect 10: The method of Aspect 9, wherein the capability report further comprises an indication of a capability for simultaneous transmission of PSFCH communications on adjacent carriers.

Aspect 11: The method of any of Aspects 9-10, wherein the capability report further comprises an indication of a capability for a number of simultaneous transmissions of PSFCH communications per carrier.

Aspect 12: The method of any of Aspects 9-11, wherein the capability report further comprises an indication of a capability for a total number of simultaneous transmissions of PSFCH communications on the number of carriers for simultaneous transmission of PSFCH communications.

Aspect 13: A method of wireless communication performed by a mobile station, comprising: determining, by the mobile station, a respective priority, for each carrier of a plurality of carriers on which a plurality of physical sidelink feedback channel (PSFCH) communications are to be received in one or more PSFCH symbols, based at least in part on priorities of one or more PSFCH communications, of the plurality of PSFCH communications, to be received on that carrier; selecting, by the mobile station, a number of carriers, of the plurality of carriers, based at least in part on the respective priority determined for each carrier, of the plurality of carriers; and receiving, in the one or more PSFCH symbols, by the mobile station from one or more other mobile stations, PSFCH communications, of the plurality of PSFCH communications, on the number of carriers selected.

Aspect 14: The method of Aspect 13, wherein the number of carriers is associated with a capability, of the mobile station, for simultaneous reception of PSFCH communications on multiple carriers.

Aspect 15: The method of any of Aspects 13-14, wherein the plurality of PSFCH communications comprises one or more hybrid automated repeat request (HARQ) acknowledgement or negative acknowledgement (ACK/NACK) PSFCH communications and one or more pre-collision PSFCH communications.

Aspect 16: The method of Aspect 15, wherein determining the respective priority, for each carrier of the plurality of carriers on which the plurality of PSFCH communications are to be received in the one or more PSFCH symbols, comprises: determining the respective priority for each carrier, of the plurality of carriers, for which the one or more PSFCH communications to be received on that carrier comprise only HARQ ACK/NACK PSFCH communications, to be higher than the respective priority for each carrier, of the plurality of carriers, for which the one or more PSFCH communications to be received on that carrier comprise only one pre-collision PSFCH communications.

Aspect 17: The method of any of Aspects 15-16, wherein determining the respective priority, for each carrier of the plurality of carriers on which the plurality of PSFCH communications are to be received in the one or more PSFCH symbols, comprises: determining the respective priority for each carrier, of the plurality of carriers, for which the one or more PSFCH communications to be received on that carrier comprise at least one HARQ ACK/NACK PSFCH communication and at least one pre-collision PSFCH communication based at least in part on a highest priority associated with the at least one HARQ ACK/NACK PSFCH communication.

Aspect 18: The method of any of Aspects 15-16, wherein determining the respective priority, for each carrier of the plurality of carriers on which the plurality of PSFCH communications are to be received in the one or more PSFCH symbols, comprises: determining the respective priority for each carrier, of the plurality of carriers, for which the one or more PSFCH communications to be received on that carrier comprise at least one HARQ ACK/NACK PSFCH communication and at least one pre-collision PSFCH communication based at least in part on a highest priority associated with the at least one HARQ ACK/NACK PSFCH communication and the at least one pre-collision PSFCH communication.

Aspect 19: The method of any of Aspects 13-18, wherein receiving the PSFCH communications, of the plurality of PSFCH communications, on the number of carriers selected comprises: receiving, on each carrier of the number of carriers selected, a quantity of the one or more PSFCH communications to be received on that carrier, wherein the quantity is based at least in part on a capability, of the mobile station, for a number of simultaneous receptions of PSFCH communications per carrier.

Aspect 20: The method of any of Aspects 13-19, wherein receiving the PSFCH communications, of the plurality of PSFCH communications, on the number of carriers selected comprises: dropping one or more lowest priority PSFCH communications, of the one or more PSFCH communications to be received on at least one carrier of the number of carriers selected, based at least in part on a capability, of the mobile station, for a total quantity of simultaneous receptions of PSFCH communications on the number of carriers.

Aspect 21: The method of any of Aspects 13-20, further comprising: transmitting, to at least one of another mobile station or a network node, a capability report that comprises an indication of a capability for a number of carriers for simultaneous reception of PSFCH communications, wherein the number of carriers selected corresponds to the capability for the number of carriers for simultaneous reception of PSFCH communications.

Aspect 22: The method of Aspect 21, wherein the capability report further comprises an indication of a capability for simultaneous reception of PSFCH communications on adjacent carriers.

Aspect 23: The method of any of Aspects 21-22, wherein the capability report further comprises an indication of a capability for a number of simultaneous receptions of PSFCH communications per carrier.

Aspect 24: The method of any of Aspects 21-23, wherein the capability report further comprises an indication of a capability for a total number of simultaneous receptions of PSFCH communications on the number of carriers for simultaneous reception of PSFCH communications.

Aspect 25: A method of wireless communication performed by a mobile station comprising: determining, by the mobile station, a transmission priority for one or more physical sidelink feedback channel (PSFCH) symbols based at least in part on first carrier priorities for a first set of carriers on which a first set of PSFCH communications are to be transmitted in the one or more PSFCH symbols; determining, by the mobile station, a reception priority for the one or more PSFCH symbols based at least in part on second carrier priorities for a second set of carriers on which a second set of PSFCH communications are to be received in the one or more PSFCH symbols; and selectively transmitting, by the mobile station, the first set of PSFCH communications on the first set of carriers in the one or more PSFCH symbols or receiving, by the mobile station, the second set of PSFCH communications on the second set of carriers in the one or more PSFCH symbols, based at least in part on the transmission priority and the reception priority.

Aspect 25: An apparatus for wireless communication at a device, comprising a processor; memory coupled with the processor; and instructions stored in the memory and executable by the processor to cause the apparatus to perform the method of one or more of Aspects 1-25.

Aspect 26: A device for wireless communication, comprising a memory and one or more processors coupled to the memory, the one or more processors configured to perform the method of one or more of Aspects 1-25.

Aspect 27: An apparatus for wireless communication, comprising at least one means for performing the method of one or more of Aspects 1-25.

Aspect 28: A non-transitory computer-readable medium storing code for wireless communication, the code comprising instructions executable by a processor to perform the method of one or more of Aspects 1-25.

Aspect 29: A non-transitory computer-readable medium storing a set of instructions for wireless communication, the set of instructions comprising one or more instructions that, when executed by one or more processors of a device, cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A mobile station for wireless communication, comprising:
a memory; and
one or more processors, configured to, based at least in part on information stored in the memory:
determine a respective priority, for each carrier of a plurality of carriers on which a plurality of physical sidelink feedback channel (PSFCH) communications are to be transmitted in one or more PSFCH symbols, based at least in part on priorities of one or more PSFCH communications, of the plurality of PSFCH communications, to be transmitted on that carrier;
select a number of carriers, of the plurality of carriers, based at least in part on the respective priority determined for each carrier, of the plurality of carriers; and
transmit, in the one or more PSFCH symbols, to one or more other mobile stations, PSFCH communications, of the plurality of PSFCH communications, on the number of carriers selected.

2. The mobile station of claim 1, wherein the number of carriers is associated with a capability, of the mobile station, for simultaneous transmission of PSFCH communications on multiple carriers.

3. The mobile station of claim 1, wherein the plurality of PSFCH communications comprises one or more hybrid automated repeat request (HARQ) acknowledgement or negative acknowledgement (ACK/NACK) PSFCH communications and one or more pre-collision PSFCH communications.

4. The mobile station of claim 3, wherein the one or more processors, to determine the respective priority, for each carrier of the plurality of carriers on which the plurality of PSFCH communications are to be transmitted in the one or more PSFCH symbols, are configured to:
determine the respective priority for each carrier, of the plurality of carriers, for which the one or more PSFCH communications to be transmitted on that carrier comprise only HARQ ACK/NACK PSFCH communications, to be higher than the respective priority for each carrier, of the plurality of carriers, for which the one or more PSFCH communications to be transmitted on that carrier comprise only pre-collision PSFCH communications.

5. The mobile station of claim 3, wherein the one or more processors, to determine the respective priority, for each carrier of the plurality of carriers on which the plurality of PSFCH communications are to be transmitted in the one or more PSFCH symbols, are configured to:
determine the respective priority for each carrier, of the plurality of carriers, for which the one or more PSFCH communications to be transmitted on that carrier comprise at least one HARQ ACK/NACK PSFCH communication and at least one pre-collision PSFCH communication based at least in part on a highest priority associated with the at least one HARQ ACK/NACK PSFCH communication.

6. The mobile station of claim 3, wherein the one or more processors, to determine the respective priority, for each carrier of the plurality of carriers on which the plurality of PSFCH communications are to be transmitted in the one or more PSFCH symbols, are configured to:
determine the respective priority for each carrier, of the plurality of carriers, for which the one or more PSFCH communications to be transmitted on that carrier comprise at least one HARQ ACK/NACK PSFCH communication and at least one pre-collision PSFCH communication based at least in part on a highest priority associated with the at least one HARQ ACK/NACK PSFCH communication and the at least one pre-collision PSFCH communication.

7. The mobile station of claim 1, wherein the one or more processors, to transmit the PSFCH communications, of the plurality of PSFCH communications, on the number of carriers selected, are configured to:
transmit, on each carrier of the number of carriers selected, a quantity of the one or more PSFCH communications to be transmitted on that carrier, wherein the quantity is based at least in part on a capability, of the mobile station, for a number of simultaneous transmissions of PSFCH communications per carrier.

8. The mobile station of claim 1, wherein the one or more processors, to transmit the PSFCH communications, of the plurality of PSFCH communications, on the number of carriers selected, are configured to:
drop one or more lowest priority PSFCH communications, of the one or more PSFCH communications to be transmitted on at least one carrier of the number of carriers selected, based at least in part on a capability, of the mobile station, for a total quantity of simultaneous transmissions of PSFCH communications on the number of carriers.

9. The mobile station of claim 1, wherein the one or more processors are further configured to:
transmit, to at least one of another mobile station or a network node, a capability report that comprises an indication of a capability for a number of carriers for simultaneous transmission of PSFCH communications, wherein the number of carriers selected corresponds to the capability for the number of carriers for simultaneous transmission of PSFCH communications.

10. The mobile station of claim 9, wherein the capability report further comprises an indication of a capability for simultaneous transmission of PSFCH communications on adjacent carriers.

11. The mobile station of claim 9, wherein the capability report further comprises an indication of a capability for a number of simultaneous transmissions of PSFCH communications per carrier.

12. The mobile station of claim 9, wherein the capability report further comprises an indication of a capability for a total number of simultaneous transmissions of PSFCH communications on the number of carriers for simultaneous transmission of PSFCH communications.

13. A mobile station for wireless communication, comprising:
a memory; and
one or more processors, configured to, based at least in part on information stored in the memory:
determine a respective priority, for each carrier of a plurality of carriers on which a plurality of physical sidelink feedback channel (PSFCH) communications are to be received in one or more PSFCH symbols, based at least in part on priorities of one or more PSFCH communications, of the plurality of PSFCH communications, to be received on that carrier;
select a number of carriers, of the plurality of carriers, based at least in part on the respective priority determined for each carrier, of the plurality of carriers; and
receive, in the one or more PSFCH symbols, from one or more other mobile stations, PSFCH communications, of the plurality of PSFCH communications, on the number of carriers selected.

14. The mobile station of claim 13, wherein the number of carriers is associated with a capability, of the mobile station, for simultaneous reception of PSFCH communications on multiple carriers.

15. The mobile station of claim 13, wherein the plurality of PSFCH communications comprises one or more hybrid automated repeat request (HARQ) acknowledgement or negative acknowledgement (ACK/NACK) PSFCH communications and one or more pre-collision PSFCH communications.

16. The mobile station of claim 15, wherein the one or more processors, to determine the respective priority, for each carrier of the plurality of carriers on which the plurality of PSFCH communications are to be received in the one or more PSFCH symbols, are configured to:
determine the respective priority for each carrier, of the plurality of carriers, for which the one or more PSFCH communications to be received on that carrier comprise only HARQ ACK/NACK PSFCH communications, to be higher than the respective priority for each carrier, of the plurality of carriers, for which the one or more PSFCH communications to be received on that carrier comprise only pre-collision PSFCH communications.

17. The mobile station of claim 15, wherein the one or more processors, to determine the respective priority, for each carrier of the plurality of carriers on which the plurality of PSFCH communications are to be received in the one or more PSFCH symbols, are configured to:
determine the respective priority for each carrier, of the plurality of carriers, for which the one or more PSFCH communications to be received on that carrier comprise at least one HARQ ACK/NACK PSFCH communication and at least one pre-collision PSFCH communication based at least in part on a highest priority associated with the at least one HARQ ACK/NACK PSFCH communication.

18. The mobile station of claim 15, wherein the one or more processors, to determine the respective priority, for each carrier of the plurality of carriers on which the plurality of PSFCH communications are to be received in the one or more PSFCH symbols, are configured to:
determine the respective priority for each carrier, of the plurality of carriers, for which the one or more PSFCH communications to be received on that carrier comprise at least one HARQ ACK/NACK PSFCH communication and at least one pre-collision PSFCH communication based at least in part on a highest priority associated with the at least one HARQ ACK/NACK PSFCH communication and the at least one pre-collision PSFCH communication.

19. The mobile station of claim 13, wherein the one or more processors, to receive the PSFCH communications, of the plurality of PSFCH communications, on the number of carriers selected, are configured to:
receive, on each carrier of the number of carriers selected, a quantity of the one or more PSFCH communications to be received on that carrier, wherein the quantity is based at least in part on a capability, of the mobile station, for a number of simultaneous receptions of PSFCH communications per carrier.

20. The mobile station of claim 13, wherein the one or more processors, to receive the PSFCH communications, of the plurality of PSFCH communications, on the number of carriers selected, are configured to:
drop one or more lowest priority PSFCH communications, of the one or more PSFCH communications to be received on at least one carrier of the number of carriers selected, based at least in part on a capability, of the mobile station, for a total quantity of simultaneous receptions of PSFCH communications on the number of carriers.

21. The mobile station of claim 13, wherein the one or more processors are further configured to:
transmit, to at least one of another mobile station or a network node, a capability report that comprises an indication of a capability for a number of carriers for simultaneous reception of PSFCH communications, wherein the number of carriers selected corresponds to the capability for the number of carriers for simultaneous reception of PSFCH communications.

22. The mobile station of claim 21, wherein the capability report further comprises an indication of a capability for simultaneous reception of PSFCH communications on adjacent carriers.

23. The mobile station of claim 21, wherein the capability report further comprises an indication of a capability for a number of simultaneous receptions of PSFCH communications per carrier.

24. The mobile station of claim 21, wherein the capability report further comprises an indication of a capability for a total number of simultaneous receptions of PSFCH communications on the number of carriers for simultaneous reception of PSFCH communications.

25. A method of wireless communication performed by a mobile station, comprising:
determining, by the mobile station, a respective priority, for each carrier of a plurality of carriers on which a plurality of physical sidelink feedback channel (PSFCH) communications are to be transmitted in one or more PSFCH symbols, based at least in part on priorities of one or more PSFCH communications, of the plurality of PSFCH communications, to be transmitted on that carrier;
selecting, by the mobile station, a number of carriers, of the plurality of carriers, based at least in part on the respective priority determined for each carrier, of the plurality of carriers; and
transmitting, in the one or more PSFCH symbols, by the mobile station to one or more other mobile stations, PSFCH communications, of the plurality of PSFCH communications, on the number of carriers selected.

26. The method of claim 25, wherein the number of carriers is associated with a capability, of the mobile station, for simultaneous transmission of PSFCH communications on multiple carriers.

27. The method of claim 25, wherein the plurality of PSFCH communications comprises one or more hybrid automated repeat request (HARQ) acknowledgement or negative acknowledgement (ACK/NACK) PSFCH communications and one or more pre-collision PSFCH communications, and wherein determining the respective priority, for each carrier of the plurality of carriers on which the plurality of PSFCH communications are to be transmitted in the one or more PSFCH symbols, comprises:
determining the respective priority for each carrier, of the plurality of carriers, for which the one or more PSFCH communications to be transmitted on that carrier comprise only HARQ ACK/NACK PSFCH communications, to be higher than the respective priority for each carrier, of the plurality of carriers, for which the one or more PSFCH communications to be transmitted on that carrier comprise only pre-collision PSFCH communications.

28-30. (canceled)
